(19) United States
(12) Patent Application Publication
(10) Pub. No.: US 2013/0276276 A1
(43) Pub. Date: Oct. 24, 2013

(54) METHOD OF MANUFACTURING AUTOMOBILE DOOR HINGE

(71) Applicants: Kazuya Ogawa, Wakayama (JP); Hiroshi Ogawa, Wakayama (JP)

(72) Inventors: Hiroshi OGAWA, Wakayama (JP); Kazuya OGAWA, Wakayama (JP); Michihiro YOKOYAMA, Tokyo (JP)

(21) Appl. No.: 13/918,098

(22) Filed: Jun. 14, 2013

Related U.S. Application Data
(63) Continuation of application No. PCT/JP2011/078240, filed on Dec. 7, 2011.

(30) Foreign Application Priority Data
Dec. 17, 2010 (JP) 2010-281433

(51) Int. Cl. E05D 5/06; B21D 53/40

(52) U.S. Cl. CPC E05D 5/062; B21D 53/40
USPC 29/11

(57) ABSTRACT

A method of manufacturing an automobile door hinge includes hot forging a round steel bar to form a forged workpiece including a mounting portion, an arm portion, and a column portion, and forming a shaft hole by punching the column portion by using a special die and a punch. The die has a gap formed therein so that, during punching, a slug is not generated and the column portion expands outward when the punch is pressed from a punching start point to a predetermined dimension, and a slug is generated and discharged when the punch is pressed from the predetermined dimension to a punching end point.

### TECHNICAL FIELD

The present invention relates to a method of manufacturing an automobile door hinge through a process including hot forging and punching, the automobile door hinge being made of steel and including a strip-shaped mounting portion and a cylindrical engagement portion that has a shaft hole into which a hinge pin is to be inserted. In particular, the present invention relates to a method of manufacturing an automobile door hinge with which a shaft hole, into which a hinge pin is to be inserted, can be formed so as to extend through the axial center of a column portion, which is formed by hot forging and which has a horizontal cross section having a circular or elliptical shape, by using a special punch and die so that the shaft hole has a height that is twice the diameter thereof or larger. With this method, an automobile door hinge having sufficient strength can be manufactured at low cost.

### BACKGROUND ART

To date, automobile door hinges made from sheet metal have been widely used, because they can be manufactured at low cost by press-forming or the like (see, for example, PTL 1).

The strength of existing automobile door hinges made from sheet metal is low. Therefore, door hinges used for large-sized cars or luxury cars, which have heavy doors, are made by cutting an extruded steel material to a predetermined length and by machining the cut steel material into a predetermined shape (see, for example, PTL 2).

### CITATION LIST

### Patent Literature

PTL 1: Japanese Unexamined Patent Application Publication No. 8-197952 (paragraph 0012, FIG. 2)
PTL 2: Japanese Unexamined Patent Application Publication No. 2008-223247 (paragraph 0002, FIG. 4)

### SUMMARY OF INVENTION

### Technical Problem

The automobile door hinge described in PTL 1, which is made from sheet metal, has a bent portion having a small thickness, and a large bending moment is applied to the bent portion. Therefore, the bent portion may be easily damaged due to a shock that occurs when the door is opened or closed.

Moreover, a hinge shaft, which rotatably connects a body-side door hinge to a door-side door hinge, is exposed to the outside. Therefore, stress concentrates on the hinge shaft when the door rotates, and the hinge shaft may be easily broken.

As described above, automobile door hinges made from sheet metal have a problem of low strength, although they are inexpensive.

The automobile door hinge described in PTL 2, which is made by machining, has sufficient strength. However, the automobile door hinge has a problem that the cost of an extruded steel material is high and the cost of machining is high, and therefore the overall manufacturing cost is high.

An object of the present invention, which address such problems of the existing technologies, is to provide a method with which an automobile door hinge having sufficient strength can be manufactured at low cost. The method includes hot forging a round steel bar to form a strip-shaped mounting portion and a column portion, which has a horizontal cross section having a circular or elliptical shape; and forming a shaft hole, into which a hinge pin is to be inserted, in the column portion so as to extend through the axial center of the column portion by using a special punch and die so that the shaft hole has a height that is twice the diameter thereof or larger.

### Solution to Problem

According to the present invention, there is provided a method of manufacturing an automobile door hinge through a process including hot forging and punching, the automobile door hinge being made of steel and including a strip-shaped mounting portion, a strip-shaped arm portion that is bent away from the mounting portion, and an engagement portion that is disposed at an end of the arm portion and that has a cylindrical shape, the engagement portion having a shaft hole into which a hinge pin is to be inserted, the method including:

a hot forging step of hot forging a round steel bar to form a strip-shaped mounting portion, a strip-shaped arm portion that is bent away from the mounting portion, and a column portion that is disposed at an end of the arm portion and that has a horizontal cross section having a circular or elliptical shape;

a shaft hole forming step of forming a shaft hole, into which a hinge pin is to be inserted, in the column portion formed in the hot forging step by using a first punch and a first die so that the shaft hole extends through an axial center of the column portion; and

a shaft hole finishing step of punching the shaft hole formed in the shaft hole forming step by using a second punch and a second die from a side of the shaft hole on which a punching end point exists at which punching with the first punch has been finished,

wherein, in the hot forging step, a round steel bar, which has been heated to 950° C. to 1350° C., is placed on a lower die, an upper die is dropped onto the round steel bar a plurality of times, and thereby a forged workpiece having a predetermined shape is formed with the dies,

wherein the lower die has a concave portion for receiving a protruding surface on a protruding side of a bent portion of the forged workpiece to be formed in the hot forging step so that the bent portion of the forged workpiece protrudes downward,

wherein the upper die has a convex portion whose shape matches that of an opposite surface of the bent portion of the forged workpiece opposite to the protruding surface,

wherein a height of the shaft hole formed in the shaft hole forming step in the column portion is 2.0 times a diameter of the shaft hole or larger,

wherein the first punch used in the shaft hole forming step includes a tip having a conical shape having a vertex angle in a range of 70° to 120°,

wherein the first die has an inner side wall that is separated from an outer periphery of the column portion of the forged workpiece with a gap therebetween, and a gap volume that is provided between the outer periphery of the column portion and the inner side wall has such a size that, during punching of the column portion of the forged workpiece using the first punch, a slug is not generated and the column portion expands outward when the first punch is pressed into the column portion from a punching start point to a predetermined dimension, and a slug is generated and discharged when the first punch is pressed into the column portion from the predetermined dimension to the punching end point,

wherein the second die has substantially the same shape as the first die, and

wherein the second punch includes a tip having a frusto-conical or conical shape having a vertex angle in a range of 70° to 120°, and the second punch has a maximum diameter that is larger than a maximum diameter of the first punch by 0.1 to 0.3 mm.

According to the present invention, there is further provided a method of manufacturing an automobile door hinge through a process including hot forging and punching, the automobile door hinge being made of steel and including a strip-shaped mounting portion, a strip-shaped arm portion that is bent away from the mounting portion, and a protrusion-including engagement portion that is disposed at an end of the arm portion and that has a cylindrical shape, the protrusion-including engagement portion having a shaft hole into which a hinge pin is to be inserted and a door stop protrusion on a distal side of the cylindrical shape, the method including:

a hot forging step of hot forging a round steel bar to form a strip-shaped mounting portion, a strip-shaped arm portion that is bent away from the mounting portion, and a protrusion-including column portion that is disposed at an end of the arm portion and that has a horizontal cross section having a circular or elliptical shape, the protrusion-including column portion having a door stop protrusion on a distal side of the circular or elliptical shape;

a shaft hole forming step of forming a shaft hole, into which a hinge pin is to be inserted, in the protrusion-including column portion formed in the hot forging step by using a first punch and a first die so that the shaft hole extends through an axial center of the protrusion-including column portion; and

a shaft hole finishing step of punching the shaft hole formed in the shaft hole forming step by using a second punch and a second die from a side of the shaft hole on which a punching end point exists at which punching with the first punch has been finished,

wherein, in the hot forging step, a round steel bar, which has been heated to 950° C. to 1350° C., is placed on a lower die, an upper die is dropped onto the round steel bar a plurality of times, and thereby a forged workpiece having a predetermined shape is formed with the dies,

wherein the lower die has a concave portion for receiving a protruding surface on a protruding side of a bent portion of the forged workpiece to be formed in the hot forging step so that the bent portion of the forged workpiece protrudes downward,

wherein the upper die has a convex portion whose shape matches that of an opposite surface of the bent portion of the forged workpiece opposite to the protruding surface,

wherein a height of the shaft hole formed in the shaft hole forming step in the protrusion-including column portion is 2.0 times a diameter of the shaft hole or larger,

wherein the first punch used in the shaft hole forming step includes a tip having a conical shape having a vertex angle in a range of 70° to 120°,

wherein the first die has an inner side wall that is separated from an outer periphery of the protrusion-including column portion of the forged workpiece with a gap therebetween, and a gap volume that is provided between the outer periphery of the protrusion-including column portion and the inner side wall has such a size that, during punching of the protrusion-including column portion of the forged workpiece using the first punch, a slug is not generated and the protrusion-including column portion expands outward when the first punch is pressed into the protrusion-including column portion from a punching start point to a predetermined dimension, and a slug is generated and discharged when the first punch is pressed into the protrusion-including column portion from the predetermined dimension to the punching end point,

wherein the second die has substantially the same shape as the first die, and

wherein the second punch includes a tip having a frusto-conical or conical shape having a vertex angle in a range of 70° to 120°, and the second punch has a maximum diameter that is larger than a maximum diameter of the first punch by 0.1 to 0.3 mm.

According to the present invention, there is further provided a method of manufacturing an automobile door hinge through a process including hot forging and punching, the automobile door hinge being made of steel and including a polygonal plate-shaped mounting portion, a strip-shaped arm portion that is bent away from the mounting portion and that has a dimension smaller than a height dimension of the mounting portion, and an engagement portion that is disposed at an end of the arm portion and that has a cylindrical shape, the engagement portion having a shaft hole into which a hinge pin is to be inserted, the method including:

a hot forging step of hot forging a round steel bar to form a polygonal plate-shaped mounting portion, a strip-shaped arm portion that is bent away from the mounting portion and that has a dimension smaller than a height dimension of the mounting portion, and a column portion that is disposed at an end of the arm portion and that has a horizontal cross section having a circular or elliptical shape;

a shaft hole forming step of forming a shaft hole, into which a hinge pin is to be inserted, in the column portion formed in the hot forging step by using a first punch and a first die so that the shaft hole extends through an axial center of the column portion; and

a shaft hole finishing step of punching the shaft hole formed in the shaft hole forming step by using a second punch and a second die from a side of the shaft hole on which a punching end point exists at which punching with the first punch has been finished,

wherein, in the hot forging step, a round steel bar, which has been heated to 950° C. to 1350° C., is placed on a lower die, an upper die is dropped onto the round steel bar a plurality of times, and thereby a forged workpiece having a predetermined shape is formed with the dies,

wherein the lower die has a concave portion for receiving a protruding surface on a protruding side of a bent portion of the forged workpiece to be formed in the hot forging step so that the bent portion of the forged workpiece protrudes downward,

wherein the upper die has a convex portion whose shape matches that of an opposite surface of the bent portion of the forged workpiece opposite to the protruding surface,

wherein a height of the shaft hole formed in the shaft hole forming step in the column portion is 2.0 times a diameter of the shaft hole or larger,

wherein the first punch used in the shaft hole forming step includes a tip having a conical shape having a vertex angle in a range of 70° to 120°,

wherein the first die has an inner side wall that is separated from an outer periphery of the column portion of the forged workpiece with a gap therebetween, and a gap volume that is provided between the outer periphery of the column portion and the inner side wall has such a size that, during punching of the column portion of the forged workpiece using the first punch, a slug is not generated and the column portion expands outward when the first punch is pressed into the column portion from a punching start point to a predetermined dimension, and a slug is generated and discharged when the first punch is pressed into the column portion from the predetermined dimension to the punching end point,

wherein the second die has substantially the same shape as the first die, and

wherein the second punch includes a tip having a frusto-conical or conical shape having a vertex angle in a range of 70° to 120°, and the second punch has a maximum diameter that is larger than a maximum diameter of the first punch by 0.1 to 0.3 mm.

According to the present invention, there is further provided a method of manufacturing an automobile door hinge through a process including hot forging and punching, the automobile door hinge being made of steel and including a polygonal plate-shaped mounting portion, a strip-shaped arm portion that is bent away from the mounting portion and that has a dimension smaller than a height dimension of the mounting portion, a protrusion-including engagement portion that is disposed at an end of the arm portion and that has a cylindrical shape, the protrusion-including engagement portion having a shaft hole into which a hinge pin is to be inserted and a door stop protrusion on a distal side of the cylindrical shape, the method including:

a hot forging step of hot forging a round steel bar to form a polygonal plate-shaped mounting portion, a strip-shaped arm portion that is bent away from the mounting portion and that has a dimension smaller than a height dimension of the mounting portion, and a protrusion-including column portion that is disposed at an end of the arm portion and that has a horizontal cross section having a circular or elliptical shape, the protrusion-including column portion having a door stop protrusion on a distal side of the circular or elliptical shape;

a shaft hole forming step of forming a shaft hole, into which a hinge pin is to be inserted, in the protrusion-including column portion formed in the hot forging step by using a first punch and a first die so that the shaft hole extends through an axial center of the protrusion-including column portion; and

a shaft hole finishing step of punching the shaft hole formed in the shaft hole forming step by using a second punch and a second die from a side of the shaft hole on which a punching end point exists at which punching with the first punch has been finished,

wherein, in the hot forging step, a round steel bar, which has been heated to 950° C. to 1350° C., is placed on a lower die, an upper die is dropped onto the round steel bar a plurality of times, and thereby a forged workpiece having a predetermined shape is formed with the dies,

wherein the lower die has a concave portion for receiving a protruding surface on a protruding side of a bent portion of the forged workpiece to be formed in the hot forging step so that the bent portion of the forged workpiece protrudes downward,

wherein the upper die has a convex portion whose shape matches that of an opposite surface of the bent portion of the forged workpiece opposite to the protruding surface,

wherein a height of the shaft hole formed in the shaft hole forming step in the protrusion-including column portion is 2.0 times a diameter of the shaft hole or larger,

wherein the first punch used in the shaft hole forming step includes a tip having a conical shape having a vertex angle in a range of 70° to 120°,

wherein the first die has an inner side wall that is separated from an outer periphery of the protrusion-including column portion of the forged workpiece with a gap therebetween, and a gap volume that is provided between the outer periphery of the protrusion-including column portion and the inner side wall has such a size that, during punching of the protrusion-including column portion of the forged workpiece using the first punch, a slug is not generated and the protrusion-including column portion expands outward when the first punch is pressed into the protrusion-including column portion from a punching start point to a predetermined dimension, and a slug is generated and discharged when the first punch is pressed into the protrusion-including column portion from the predetermined dimension to the punching end point,

wherein the second die has substantially the same shape as the first die, and

wherein the second punch includes a tip having a frusto-conical or conical shape having a vertex angle in a range of 70° to 120°, and the second punch has a maximum diameter that is larger than a maximum diameter of the first punch by 0.1 to 0.3 mm.

According to the present invention, there is further provided a method of manufacturing an automobile door hinge through a process including hot forging and punching, the automobile door hinge being made of steel and including a strip-shaped mounting portion and a protrusion-including engagement portion that is disposed in a portion bent away from the mounting portion and that has a cylindrical shape, the protrusion-including engagement portion having a shaft hole into which a hinge pin is to be inserted and a door stop protrusion on a distal side of the cylindrical shape, the method including:

a hot forging step of hot forging a round steel bar to form a strip-shaped mounting portion and a protrusion-including column portion that is disposed in a portion bent away from the mounting portion and that has a horizontal cross section having a circular or elliptical shape, the protrusion-including column portion having a door stop protrusion on a distal side of the circular or elliptical shape;

a shaft hole forming step of forming a shaft hole, into which a hinge pin is to be inserted, in the protrusion-including column portion formed in the hot forging step by using a first punch and a first die so that the shaft hole extends through an axial center of the protrusion-including column portion; and

a shaft hole finishing step of punching the shaft hole formed in the shaft hole forming step by using a second punch and a second die from a side of the shaft hole on which a punching end point exists at which punching with the first punch has been finished,

wherein, in the hot forging step, a round steel bar, which has been heated to 950° C. to 1350° C., is placed on a lower die, an upper die is dropped onto the round steel bar a plurality of times, and thereby a forged workpiece having a predetermined shape is formed with the dies,

wherein the lower die has a concave portion for receiving a protruding surface on a protruding side of a bent portion of the forged workpiece to be formed in the hot forging step so that the bent portion of the forged workpiece protrudes downward,

wherein the upper die has a convex portion whose shape matches that of an opposite surface of the bent portion of the forged workpiece opposite to the protruding surface,

wherein a height of the shaft hole formed in the shaft hole forming step in the protrusion-including column portion is 2.0 times a diameter of the shaft hole or larger,

wherein the first punch used in the shaft hole forming step includes a tip having a conical shape having a vertex angle in a range of 70° to 120°,

wherein the first die has an inner side wall that is separated from an outer periphery of the protrusion-including column portion of the forged workpiece with a gap therebetween, and a gap volume that is provided between the outer periphery of the protrusion-including column portion and the inner side wall has such a size that, during punching of the protrusion-including column portion of the forged workpiece using the first punch, a slug is not generated and the protrusion-including column portion expands outward when the first punch is pressed into the protrusion-including column portion from a punching start point to a predetermined dimension, and a slug is generated and discharged when the first punch is pressed into the protrusion-including column portion from the predetermined dimension to the punching end point,

wherein the second die has substantially the same shape as the first die, and

wherein the second punch includes a tip having a frusto-conical or conical shape having a vertex angle in a range of 70° to 120°, and the second punch has a maximum diameter that is larger than a maximum diameter of the first punch by 0.1 to 0.3 mm.

According to the present invention, there is further provided a method of manufacturing an automobile door hinge through a process including hot forging and punching, the automobile door hinge being made of steel and including a strip-shaped mounting portion and an engagement portion that is disposed in a portion bent away from the mounting portion and that has a cylindrical shape, the engagement portion having a shaft hole into which a hinge pin is to be inserted, the method including:

a hot forging step of hot forging a round steel bar to form a strip-shaped mounting portion and a column portion that is disposed in a portion bent away from the mounting portion and that has a horizontal cross section having a circular or elliptical shape;

a shaft hole forming step of forming a shaft hole, into which a hinge pin is to be inserted, in the column portion formed in the hot forging step by using a first punch and a first die so that the shaft hole extends through an axial center of the column portion; and

a shaft hole finishing step of punching the shaft hole formed in the shaft hole forming step by using a second punch and a second die from a side of the shaft hole on which a punching end point exists at which punching with the first punch has been finished;

wherein, in the hot forging step, a round steel bar, which has been heated to 950° C. to 1350° C., is placed on a lower die, an upper die is dropped onto the round steel bar a plurality of times, and thereby a forged workpiece having a predetermined shape is formed with the dies,

wherein the lower die has a concave portion for receiving a protruding surface on a protruding side of a bent portion of the forged workpiece to be formed in the hot forging step so that the bent portion of the forged workpiece protrudes downward,

wherein the upper die has a convex portion whose shape matches that of an opposite surface of the bent portion of the forged workpiece opposite to the protruding surface,

wherein a height of the shaft hole formed in the shaft hole forming step in the column portion is 2.0 times a diameter of the shaft hole or larger,

wherein the first punch used in the shaft hole forming step includes a tip having a conical shape having a vertex angle in a range of 70° to 120°,

wherein the first die has an inner side wall that is separated from an outer periphery of the column portion of the forged workpiece with a gap therebetween, and a gap volume that is provided between the outer periphery of the column portion and the inner side wall has such a size that, during punching of the column portion of the forged workpiece using the first punch, a slug is not generated and the column portion expands outward when the first punch is pressed into the column portion from a punching start point to a predetermined dimension, and a slug is generated and discharged when the first punch is pressed into the column portion from the predetermined dimension to the punching end point,

wherein the second die has substantially the same shape as the first die, and

wherein the second punch includes a tip having a frusto-conical or conical shape having a vertex angle in a range of 70° to 120°, and the second punch has a maximum diameter that is larger than a maximum diameter of the first punch by 0.1 to 0.3 mm.

The method of manufacturing an automobile door hinge of the present invention may further include a trimming step of removing a burr of the forged workpiece formed in the hot forging step by using a trimming press,

wherein the trimming step is performed after the hot forging step while the forged workpiece is hot.

According to the present invention, in the hot forging step, a round steel bar having a temperature in the range of 1200° C.±50° C. may be forged.

According to the present invention, the shaft hole forming step may be performed by cold working.

### Advantageous Effects of Invention

The method of manufacturing an automobile door hinge according to the present invention includes a hot forging step of hot forging a round steel bar to form a strip-shaped mounting portion, a strip-shaped arm portion that is bent away from the mounting portion, and a column portion or a protrusion-including column portion that is disposed at an end of the arm portion and that has a horizontal cross section having a circular or elliptical shape; a shaft hole forming step of forming a shaft hole, into which a hinge pin is to be inserted, in the column portion or the protrusion-including column portion formed in the hot forging step by using a first punch and a first die so that the shaft hole extends through an axial center of the column portion or the protrusion-including column portion; and a shaft hole finishing step of punching the shaft hole formed in the shaft hole forming step by using a second punch and a second die from a side of the shaft hole on which a punching end point exists at which punching with the first punch has been finished. In the hot forging step, a round steel bar, which has been heated to 950° C. to 1350° C., is placed on a lower die, an upper die is dropped onto the round steel bar a plurality of times, and thereby a forged workpiece having a predetermined shape is formed with the dies. The first punch used in the shaft hole forming step includes a tip having a conical shape having a vertex angle in a range of 70° to 120°. The first die has an inner side wall that is separated from an outer periphery of the column portion or the protrusion-including column portion of the forged workpiece with a gap therebetween; and a gap volume that is provided between the outer periphery of the column portion or the protrusion-including column portion and the inner side wall has such a size that, during punching of the column portion or the protrusion-including column portion of the forged workpiece using the first punch, a slug is not generated and the column portion or the protrusion-including column portion expands outward when the first punch is pressed into the column portion or the protrusion-including column portion from a punching start point to a predetermined dimension, and a slug is generated and discharged when the first punch is pressed into the column portion or the protrusion-including column portion from the predetermined dimension to the punching end point. Therefore, the method has advantageous effects that a shaft hole having a height that is twice the diameter thereof or larger can be formed by punching, and an automobile door hinge having sufficient strength can be manufactured at low cost through a process including hot forging and punching a round steel bar.

The method of manufacturing an automobile door hinge according to the present invention may include a hot forging step of hot forging a round steel bar to form a polygonal plate-shaped mounting portion, a strip-shaped arm portion that is bent away from the mounting portion and that has a dimension smaller than a height dimension of the mounting portion, and a column portion or a protrusion-including column portion that is disposed at an end of the arm portion and that has a horizontal cross section having a circular or elliptical shape; a shaft hole forming step of forming a shaft hole, into which a hinge pin is to be inserted, in the column portion or the protrusion-including column portion formed in the hot forging step by using a first punch and a first die so that the shaft hole extends through an axial center of the column portion or the protrusion-including column portion; and a shaft hole finishing step of punching the shaft hole formed in the shaft hole forming step by using a second punch and a second die from a side of the shaft hole on which a punching end point exists at which punching with the first punch has been finished. In the hot forging step, a round steel bar, which has been heated to 950° C. to 1350° C., is placed on a lower die, an upper die is dropped onto the round steel bar a plurality of times, and thereby a forged workpiece having a predetermined shape is formed with the dies. The first punch used in the shaft hole forming step includes a tip having a conical shape having a vertex angle in a range of 70° to 120°. The first die has an inner side wall that is separated from an outer periphery of the column portion or the protrusion-including column portion of the forged workpiece with a gap therebetween; and a gap volume that is provided between the outer periphery of the column portion or the protrusion-including column portion and the inner side wall has such a size that, during punching of the column portion or the protrusion-including column portion of the forged workpiece formed in the hot forging step using the first punch, a slug is not generated and the column portion or the protrusion-including column portion expands outward when the first punch is pressed into the column portion or the protrusion-including column portion from a punching start point to a predetermined dimension, and a slug is generated and discharged when the first punch is pressed into the column portion or the protrusion-including column portion from the predetermined dimension to the punching end point. Therefore, the method has advantageous effects that a shaft hole having a height that is twice the diameter thereof or larger can be formed by punching, and an automobile door hinge having sufficient strength can be manufactured at low cost through a process including hot forging and punching a round steel bar.

The method of manufacturing an automobile door hinge according to the present invention may include a hot forging step of hot forging a round steel bar to form a strip-shaped mounting portion and a protrusion-including column portion or a column portion that is disposed in a portion bent away from the mounting portion and that has a horizontal cross section having a circular or elliptical shape; a shaft hole forming step of forming a shaft hole, into which a hinge pin is to be inserted, in the protrusion-including column portion or the column portion formed in the hot forging step by using a first punch and a first die so that the shaft hole extends through an axial center of the protrusion-including column portion or the column portion; and a shaft hole finishing step of punching the shaft hole formed in the shaft hole forming step by using a second punch and a second die from a side of the shaft hole on which a punching end point exists at which punching with the first punch has been finished. In the hot forging step, a round steel bar, which has been heated to 950° C. to 1350° C., is placed on a lower die, an upper die is dropped onto the round steel bar a plurality of times, and thereby a forged workpiece having a predetermined shape is formed with the dies. The first punch used in the shaft hole forming step includes a tip having a conical shape having a vertex angle in a range of 70° to 120°. The first die has an inner side wall that is separated from an outer periphery of the protrusion-including column portion or the column portion of the forged workpiece with a gap therebetween; and a gap volume that is provided between the outer periphery of the protrusion-including column portion or the column portion and the inner side wall has such a size that, during punching of the protrusion-including column portion or the column portion of the forged workpiece using the first punch, a slug is not generated and the protrusion-including column portion or the column portion expands outward when the first punch is pressed into the protrusion-including column portion or the column portion from a punching start point to a predetermined dimension, and a slug is generated and discharged when the first punch is pressed into the protrusion-including column portion or the column portion from the predetermined dimension to the punching end point. Therefore, the method has advantageous effects that a shaft hole having a height that is twice the diameter thereof or larger can be formed by punching, and an automobile door hinge having sufficient strength can be manufactured at low cost through a process including hot forging and punching a round steel bar.

The method of manufacturing an automobile door hinge according to the present invention may further include a trimming step of removing a burr of the forged workpiece formed in the hot forging step by using a trimming press, and the trimming step is performed after the hot forging step while the forged workpiece is hot. Therefore, the method further has advantageous effects that press trimming for which precision is not required can be performed easily, and the size a processing machine can be reduced.

In the method of manufacturing an automobile door hinge according to the present invention, a round steel bar having a temperature in the range of 1200° C.±50° C. may be forged in the hot forging step. Therefore, the method further has an advantageous effect that the quality of the forged workpiece formed in the hot forging step can be controlled to be in a certain range.

In the method of manufacturing an automobile door hinge according to the present invention, the shaft hole forming step may be performed by cold working. Therefore, the method further has an advantageous effect that the precision of the shaft hole formed in the shaft hole forming step can be increased.

### BRIEF DESCRIPTION OF DRAWINGS

FIG. 1 is a block diagram according to a first embodiment of the present invention.

FIG. 2 is a perspective view of a body-side door hinge according to the first embodiment of the present invention.

FIG. 3 illustrates a cutting step according to the first embodiment of the present invention.

FIG. 4 illustrates a hot forging step according to the first embodiment of the present invention.

FIG. 5 is a perspective view of a forged workpiece formed by the hot forging step according to the first embodiment of the present invention.

FIG. 6 illustrates a trimming step according to the first embodiment of the present invention.

FIG. 7 is a front view of a first punch according to the first embodiment of the present invention.

FIG. 8 is a plan view of a first die according to the first embodiment of the present invention.

FIG. 9 is an enlarged partial plan view illustrating a column portion and the first die according to the first embodiment of the present invention.

FIG. 10 is a sectional view of upper and lower die sets used in a shaft hole forming step according to the first embodiment of the present invention.

FIG. 11 is a front view of a second punch according to the first embodiment of the present invention.

FIG. 12 is a plan view of a second die according to the first embodiment of the present invention.

FIG. 13 is a sectional view of upper and lower die sets used in a shaft hole finishing step according to the first embodiment of the present invention.

FIG. 14 is a sectional view illustrating a shear droop portion according to the first embodiment of the present invention.

FIG. 15 illustrates a hole forming step according to the first embodiment of the present invention.

FIG. 16 is a perspective view of a body-side door hinge according to a second embodiment of the present invention.

FIG. 17 illustrates a hot forging step according to the second embodiment of the present invention.

FIG. 18 is an enlarged partial plan view illustrating a protrusion-including column portion and a first die according to the second embodiment of the present invention.

FIG. 19 is a sectional view of upper and lower die sets used in a shaft hole forming step according to the second embodiment of the present invention.

FIG. 20 is a sectional view of upper and lower die sets used in a shaft hole finishing step according to the second embodiment of the present invention.

FIG. 21 is a perspective view of a body-side door hinge according to a third embodiment of the present invention.

FIG. 22 illustrates a hot forging step according to the third embodiment of the present invention.

FIG. 23 is a plan view of a first die according to the third embodiment of the present invention.

FIG. 24 is a sectional view of upper and lower die sets used in a shaft hole forming step according to the third embodiment of the present invention.

FIG. 25 is a sectional view of upper and lower die sets used in a shaft hole finishing step according to the third embodiment of the present invention.

FIG. 26 is a perspective view of a body-side door hinge according to a fourth embodiment of the present invention.

FIG. 27 illustrates a hot forging step according to the fourth embodiment of the present invention.

FIG. 28 is a plan view of a first die according to the fourth embodiment of the present invention.

FIG. 29 is a sectional view of upper and lower die sets used in a shaft hole forming step according to the fourth embodiment of the present invention.

FIG. 30 is a sectional view of upper and lower die sets used in a shaft hole finishing step according to the fourth embodiment of the present invention.

FIG. 31 is a perspective view of a door-side door hinge according to a fifth embodiment of the present invention.

FIG. 32 illustrates a hot forging step according to the fifth embodiment of the present invention.

FIG. 33 is a plan view of a first die according to the fifth embodiment of the present invention.

FIG. 34 is an enlarged partial plan view illustrating a protrusion-including column portion and a first die according to the fifth embodiment of the present invention.

FIG. 35 is a sectional view of upper and lower die sets used in a shaft hole finishing step according to the fifth embodiment of the present invention.

FIG. 36 is a sectional view of upper and lower die sets used in a shaft hole finishing step according to the fifth embodiment of the present invention.

FIG. 37 is a perspective view of a door-side door hinge according to a sixth embodiment of the present invention.

FIG. 38 illustrates a hot forging step according to the sixth embodiment of the present invention.

FIG. 39 is a plan view of a first die according to the sixth embodiment of the present invention.

FIG. 40 is an enlarged partial plan view illustrating a column portion and a first die according to the sixth embodiment of the present invention.

FIG. 41 is a sectional view of upper and lower die sets used in a shaft hole forming step according to the sixth embodiment of the present invention.

FIG. 42 is a sectional view of upper and lower die sets in a shaft hole finishing step according to the sixth embodiment of the present invention.

FIGS. 43A and 43B are enlarged partial plan views illustrating modifications of the first to sixth embodiments of the present invention, FIG. 43A illustrating a column portion and a first die, and FIG. 43B illustrating a protrusion-including column portion and a first die.

FIG. 44A is a perspective view and FIG. 44B is a front view of a pair of automobile door hinges according to a seventh embodiment of the present invention.

FIG. 45A is a perspective view and FIG. 45B is a front view of a pair of automobile door hinges according to an eighth embodiment of the present invention.

FIG. 46A is a perspective view and FIG. 46B is a front view of a pair of automobile door hinges according to a ninth embodiment of the present invention.

FIG. 47A is a perspective view and FIG. 47B is a front view of a pair of automobile door hinges according to a tenth embodiment of the present invention.

### DESCRIPTION OF EMBODIMENTS

Hereinafter, embodiments of the present invention will be described in detail with reference to the attached drawings.

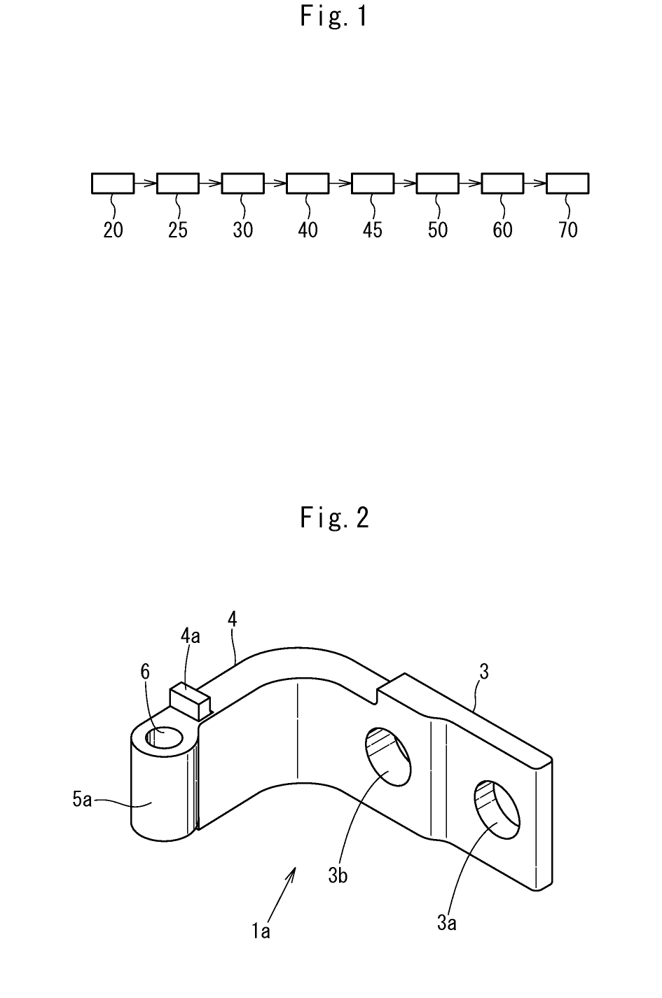

Referring FIGS. 1 to 15, a method of manufacturing an automobile door hinge according to a first embodiment of the present invention will be described.

First, the outline of the method of manufacturing an automobile door hinge according to the first embodiment of the present invention will be described with reference to FIG. 1, which is a block diagram.

The manufacturing method according to the first embodiment includes a cutting step 20, a heating step 25, a hot forging step 30, a trimming step 40, a cooling step 45, a shaft hole forming step 50, a shaft hole finishing step 60, and a hole forming step 70.

FIG. 2 illustrates a body-side door hinge 1a, which is to be attached to an automobile body, made by the manufacturing method according to the first embodiment. As illustrated in FIG. 2, the body-side door hinge 1a includes a strip-shaped mounting portion 3, a strip-shaped arm portion 4 that is bent away from the mounting portion 3, and an engagement portion 5a that is formed at an end of the arm portion 4 and that has a cylindrical shape. The engagement portion 5a has a shaft hole 6 into which a hinge pin is to be inserted. A stopper 4a is formed on the arm portion 4, and mounting holes 3a and 3b are formed in the mounting portion 3.

Referring to FIG. 1 and FIGS. 3 to 15, the steps 20 to 70 for manufacturing the body-side door hinge 1a will be described sequentially.

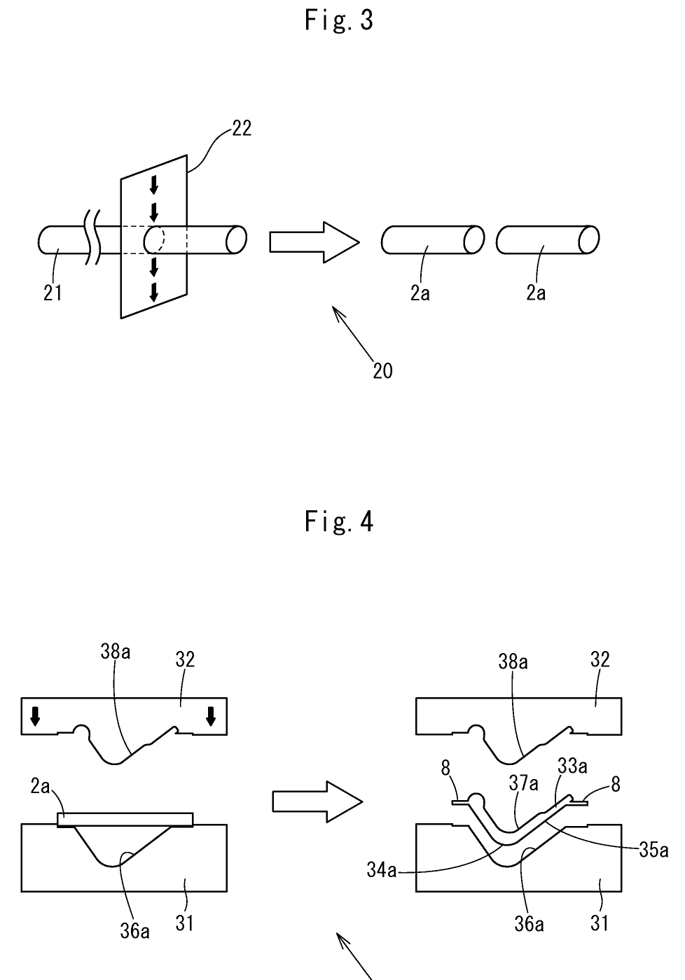

In the cutting step 20 illustrated in FIG. 3, a scale-covered round steel bar 21, which is made of S45C steel and which has a diameter of 23 mm and a length of 5500 mm, is cut to round steel bar materials 2a each having a diameter of 23 mm and a length of 125 mm by using a cutting machine 22.

Next, in the heating step 25 (see FIG. 1), although not illustrated, a conveyer conveys each of the materials 2a, which has been formed in the cutting step 20, through a heating furnace so that the material 2a is heated to a temperature in the range of 1200° C.±50° C., and then the material 2a is conveyed out of the heating furnace.

The heating furnace uses electric power or fuel gas as a heat source. The electric power or a gas burner is adjusted so that the material 2a has a temperature in the range of 1200° C.±50° C. when the material 2a is conveyed out of the heating furnace.

The conveyer conveys the material 2a through the heating furnace in six seconds, which match a production takt time of the hot forging step 30 to be performed next.

The material 2a, which has been heated to 1200° C.±50° C. in the heating furnace, is hot forged in the hot forging step 30 illustrated in FIG. 4.

In the hot forging step 30, hot forging is performed by using an air stamp hammer (not shown), a lower die 31, and an upper die 32. The lower and upper dies 31 and 32 are made of a hot work die steel that has high hardness and high corrosion resistance (such as SKD61 steel).

Before starting hot forging, the lower die 31 and the upper die 32 are heated to about 150° C. Then, the round steel bar material 2a, which has been heated to 1200° C.±50° C. in the heating step 25, is placed on the lower die 31. The upper die 32 is dropped onto the material 2a a plurality of times (for example, three times), and thereby a forged workpiece 33a having a predetermined shape is formed with the dies 31 and 32.

The lower die 31 has a concave portion 36a for receiving a protruding surface 35a on a protruding side of a bent portion 34a of the forged workpiece 33a formed in the hot forging step 30 so that the bent portion 34a of the forged workpiece 33a protrudes downward.

The upper die 32 has a convex portion 38a whose shape matches that of an opposite surface 37a of the bent portion 34a of the forged workpiece 33a opposite to the protruding surface.

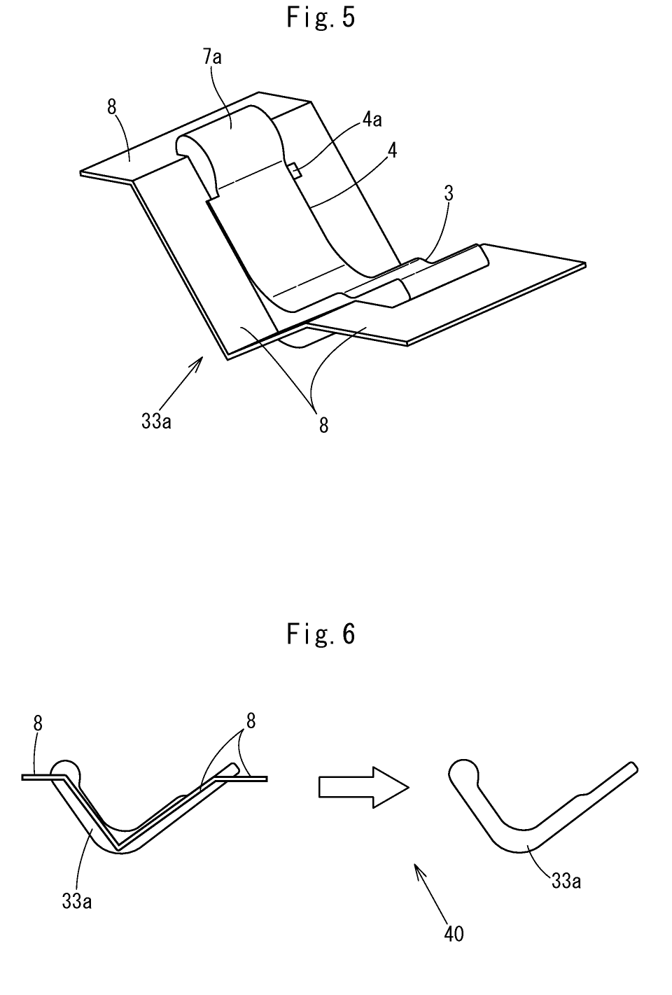

As illustrated in FIG. 5, the forged workpiece 33a includes a strip-shaped mounting portion 3, a strip-shaped arm portion 4 that is bent away from the mounting portion 3, a column portion 7a that is disposed at an end of the arm portion 4 and that has a horizontal cross section having a circular shape, a stopper 4a that is formed on the arm portion 4, and a burr 8 that is formed outward from these members.

The burr 8 of the forged workpiece 33a is generated in a gap between mating faces the lower die 31 and the upper die 32.

The sizes of the lower die 31 and the upper die 32 are determined with consideration of thermal expansion of the forged workpiece 33a during hot forging and thermal contraction during use at room temperature.

That is, the lower die 31 and the upper die 32 are manufactured so as to have dimensions that are larger than the design values for use at room temperature with consideration of the coefficients of thermal expansion and the temperatures (for example, 200° C.) of the lower and upper dies 31 and 32 during hot forging and the coefficient of thermal expansion and the temperature (for example, 1200° C.) of the forged workpiece 33a during hot forging.

Next, the trimming step 40 for trimming and removing the burr 8 of the forged workpiece 33a, which has been formed in the hot forging step 30, is performed.

In the trimming step 40 illustrated in FIG. 6, the burr 8 of the forged workpiece 33a is punched and removed by using a trimming press (not shown) while the forged workpiece 33a is hot after the hot forging step 30.

The trimming step 40 is performed while the forged workpiece 33a is hot, because dimensional accuracy is not required when removing the burr 8 of the forged workpiece 33a. By doing so, a trimming press having low capacity can be used.

In the cooling step 45 (see FIG. 1), the forged workpiece 33a, which is hot after the trimming step 40, is naturally cooled to room temperature for several hours in the atmosphere.

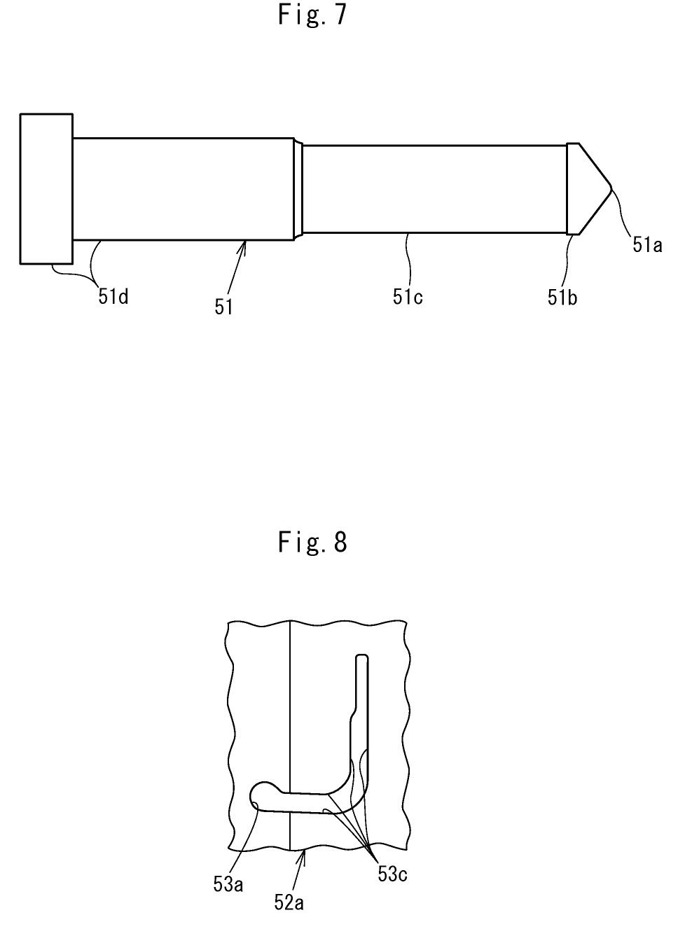

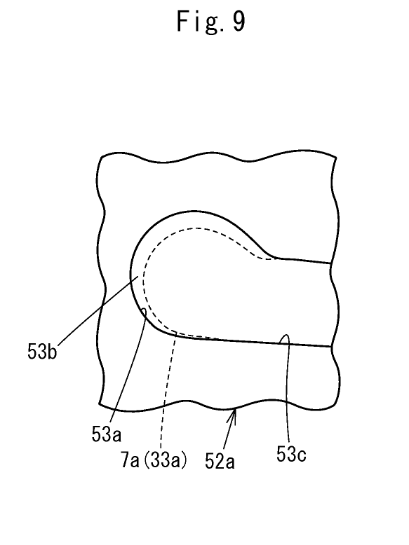

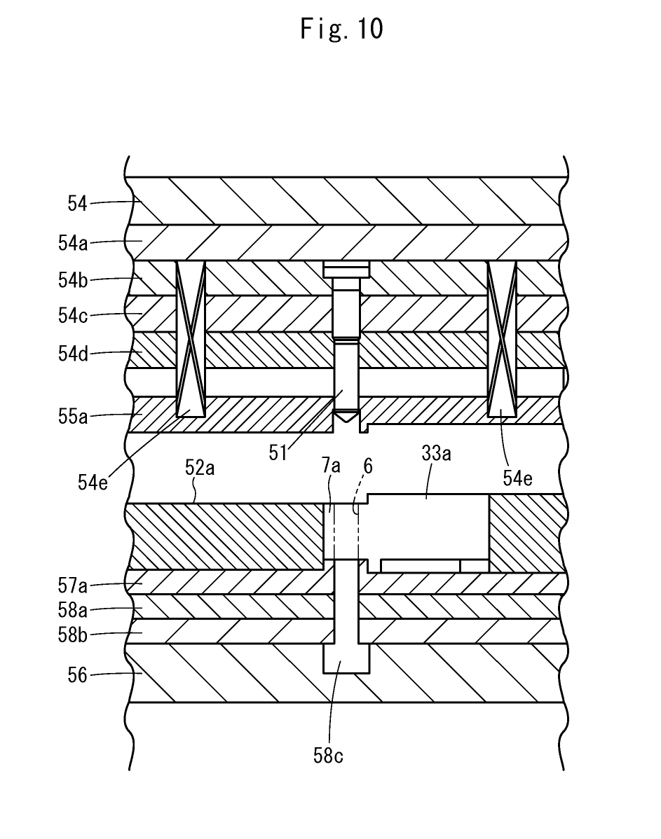

Next, referring to FIGS. 7 to 10, the shaft hole forming step 50 will be described. FIG. 7 illustrates a first punch, FIG. 8 is a plan view of a first die, FIG. 9 is an enlarged plan view of a column portion of a forged workpiece and the first die, and FIG. 10 is a sectional view of upper and lower die sets.

In the shaft hole forming step 50, the shaft hole 6, into which a hinge pin is to be inserted, is formed in the column portion 7a of the forged workpiece 33a after the cooling step 45 by using a first punch 51 and a first die 52a, so that the shaft hole 6 extends through the axial center of the column portion 7a.

The first punch 51, which is illustrated in FIG. 7, includes a tip, a shaft portion 51c, and a shank 51d. The tip includes a rounded end portion 51a, a conical portion, and a cylindrical portion 51b. The radius of the rounded end portion 51a is 1 mm, and the vertex angle of the conical portion is 90°. The maximum diameter of the conical portion and the diameter of the cylindrical portion 51b are 8.6 mm. The length of the cylindrical portion 51b is 1 mm. The diameter of the shaft portion 51c is smaller than that of the cylindrical portion 51b by 0.2 mm.

As illustrated in FIG. 9, the first die 52a illustrated FIG. 8 has an inner side wall 53a that is separated from an outer periphery of the column portion 7a (shown by a dotted line) of the forged workpiece 33a with a gap therebetween. A gap volume 53b that is provided between the outer periphery of the column portion 7a and the inner side wall 53a has such a size that, during punching of the column portion 7a of the forged workpiece 33a using the first punch 51, a slug is not generated and the column portion 7a expands outward when the first punch 51 is pressed into the column portion 7a from a punching start point to a position at ⅘ of the length of the column portion 7a, and a slug is generated and discharged when the first punch 51 is pressed into the column portion 7a from the position at ⅘ of the length of the column portion 7a to a punching end point.

An inner side wall 53c of the first die 52a, which does not face the column portion 7a, has such a shape that the inner side wall 53c comes into contact with the outer peripheries of the mounting portion 3 and the arm portion 4 of the forged workpiece 33a without a gap therebetween. The column portion 7a of the forged workpiece 33a is positioned with respect to the inner side wall 53c.

By using the first punch 51, the first die 52a, and a transfer press having a capacity of 500 ton, the shaft hole 6 is formed in the axial center of the column portion 7a.

As illustrated in FIG. 10, the transfer press used in the shaft hole forming step has an upper die set 54, which moves up and down, and a lower die set 56, which is fixed to the transfer press. The first punch 51 is attached to the upper die set 54 using a punch plate 54a; punch holders 54b, 54c, and 54d; springs 54e; a stripper 55a; and the like. The first die 52a is attached to the lower die set 56 using a die holder 57a, die plates 58a and 58b, and the like.

Then, the forged workpiece 33a is inserted into the first die 52a. The upper die set 54 is lowered so that the stripper 55a of the upper die set 54 contacts the first die 52a. The forged workpiece 33a, excluding a portion in which the shaft hole 6 is to be formed, is vertically fixed between the stripper 55a and the die holder 57a using the springs 54e. Then, the shaft hole 6 is formed by lowering the first punch 51. When the first punch 51 is pressed into the column portion 7a from a punching start point to a position at ⅘ of the length of the column portion 7a, a slug is not generated and the column portion 7a expands outward so as to fill the gap volume 53b in the first die 52a. When the first punch 51 is pressed further into the column portion 7a from the position at ⅘ of the length of the column portion 7a to the punching end point, a slug is generated and discharged to the outside through a slug discharge hole 58c.

Next, the upper die set 54 is lifted to the initial position, a hydraulic device (not shown) pushes up the forged workpiece 33a, in which the shaft hole 6 has been formed, so as to remove the forged workpiece 33a from the first die 52a, thereby finishing the shaft hole forming step 50.

Thus, in the shaft hole forming step 50, the column portion 7a of the forged workpiece 33a is formed into the engagement portion 5a, which has a cylindrical shape having an inside diameter of 8.8 mm and a height of 24 mm.

After the shaft hole forming step 50, the forged workpiece 33a is turned upside down, and the shaft hole 6, which has been formed in the engagement portion 5a of the forged workpiece 33a, is finished in the shaft hole finishing step 60 by using the transfer press.

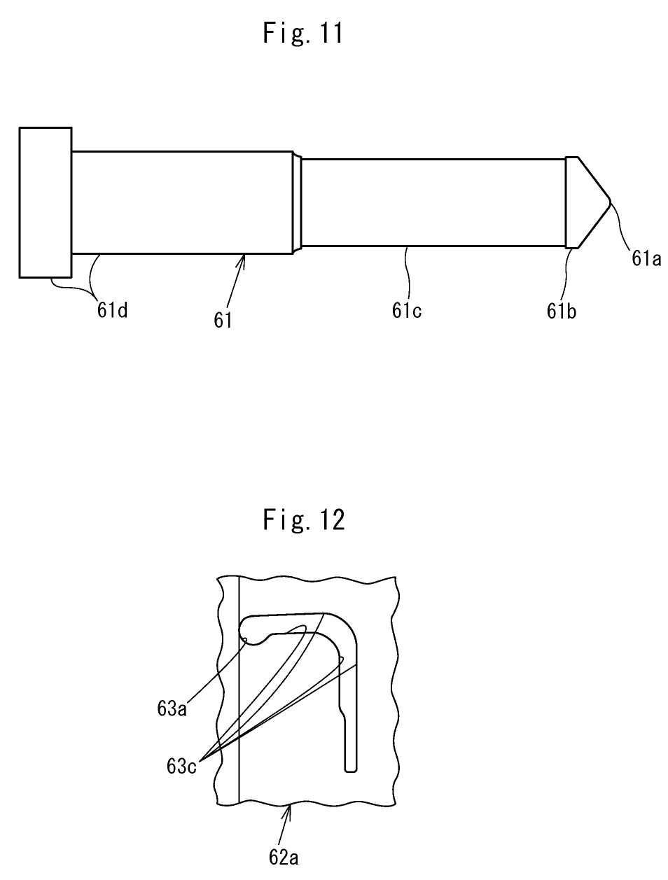

As illustrated in FIGS. 11 to 13, in the shaft hole finishing step 60, the shaft hole 6, which has been formed in the engagement portion 5a of the forged workpiece 33a in the shaft hole forming step 50, is finished with high precision by using a second punch 61 and a second die 62a.

The second punch 61, which is illustrated in FIG. 11, includes a tip, a shaft portion 61c, and a shank 61d. The tip includes a rounded end portion 61a, a conical portion, and a cylindrical portion 61b. The radius of the rounded end portion 61a is 1 mm, and the vertex angle of the conical portion is 90°. The maximum diameter of the conical portion and the diameter of the cylindrical portion 61b are 8.8 mm. The length of the cylindrical portion 61b is 1 mm. The diameter of the shaft portion 61c is smaller than that of the cylindrical portion 61b by 0.2 mm. The second punch 61 differs from the first punch 51 in that the maximum diameter of the conical portion, the diameter of the cylindrical portion 61b, and the diameter of the shaft portion 61c are respectively larger than the maximum diameter of the conical portion, the diameter of the cylindrical portion 51b, and the diameter of the shaft portion 51c of the first punch 51 by 0.2 mm, so that finishing can be performed.

The second die 62a illustrated in FIG. 12 has an inner side wall having a shape the same as that of the first die 52a. The inner side wall includes an inner side wall 63a, whose shape matches that of the expanded outer periphery of the engagement portion 5a of the forged workpiece 33a, and an inner side wall 63c, whose shape matches that of the outer peripheries of the mounting portion 3 and the arm portion 4. The outer periphery of the forged workpiece 33a comes into contact with the inner side walls 63a and 63c without a gap therebetween.

As illustrated in FIGS. 8 and 12, because the forged workpiece 33a is inserted into the first die 52a and the second die 62a in vertically opposite orientations, the first die 52a and the second die 62a have shapes that are vertically symmetric to each other.

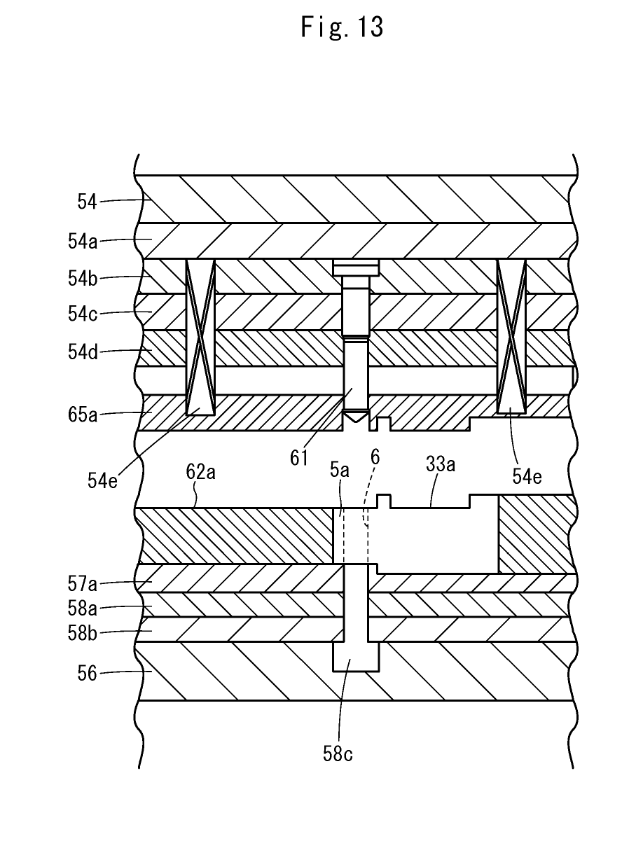

Also in the shaft hole finishing step 60, the transfer press used in the shaft hole forming step 50 is used. As illustrated in FIG. 13, the second punch 61 is attached to the upper die set 54, and the second die 62a is fixed to the lower die set 56.

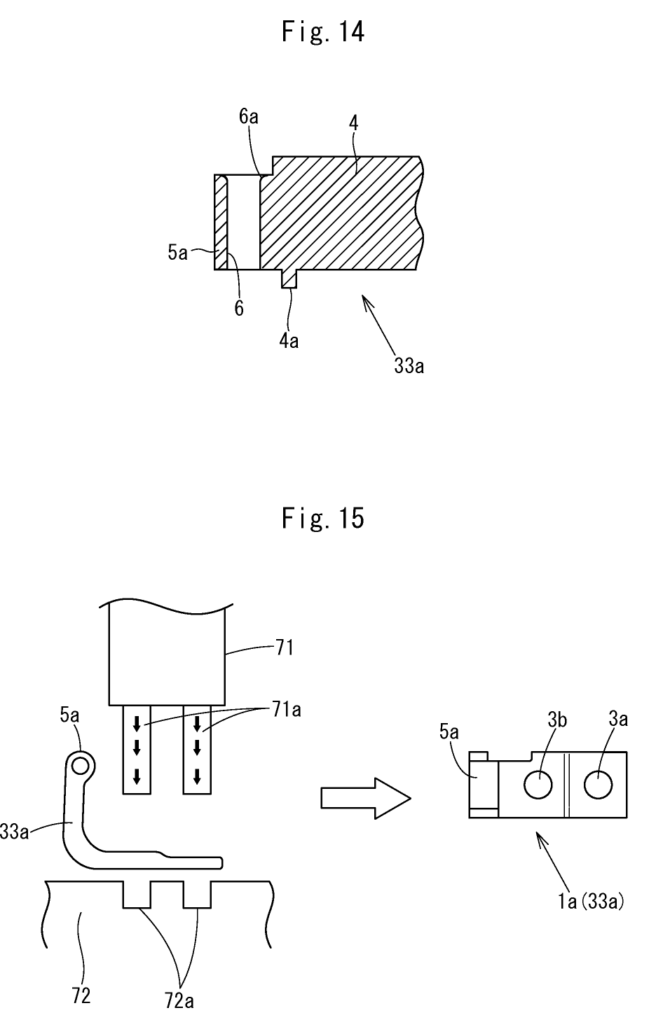

The maximum diameter of the second punch 61 used in the shaft hole finishing step 60 is larger than the maximum diameter of the first punch 51 used in the shaft hole forming step 50 by 0.2 mm. The forged workpiece 33a cannot expand vertically due to the presence of the stripper 65a and the die holder 57a and cannot expand outward due to the presence of the second die 62a. Therefore, the diameter of the shaft hole 6 is increased by 0.2 mm in the shaft hole finishing step 60. At this time, excess metal does not become a slug but serves to compensate for a shear droop portion 6a, which is formed adjacent to a punching start point of the shaft hole forming step 50 as illustrated in FIG. 14, or is absorbed in a small gap between the engagement portion 5a and the inner side wall 63a of the second die 62a.

By using the second punch 61, the second die 62a, and a transfer press having a capacity of 500 ton, the shaft hole 6 having a diameter of about 8.8 mm, which has been formed in the engagement portion 5a, is finished so as to have a diameter of 9.0 mm.

Referring to FIG. 13, the shaft hole finishing step will be described using the same numerals for the components the same as those of the shaft hole forming step 50. The transfer press has an upper die set 54, which moves up and down, and a lower die set 56, which is fixed to the transfer press. The second punch 61 is attached to the upper die set 54 using the punch plate 54a; the punch holders 54b, 54c, and 54d; a stripper 65a; the springs 54e; and the like. The second die 62a is attached to the lower die set 56 using the die holder 57a, the die plates 58a and 58b, and the like.

Then, the forged workpiece 33a is turned upside down and inserted into the second die 62a. The upper die set 54 is lowered so that the stripper 65a of the upper die set 54 contacts the second die 62a. The forged workpiece 33a, excluding a portion in which the shaft hole 6 is to be formed, is vertically fixed between the stripper 65a and the die holder 57a using the springs 54e. Then, the shaft hole 6 is finished by lowering the second punch 61.

Next, the upper die set 54 is lifted to the initial position, a hydraulic device (not shown) pushes up the forged workpiece 33a having the finished shaft hole 6, so as to remove the forged workpiece 33a from the second die 62a, thereby finishing the shaft hole finishing step 60.

After the shaft hole finishing step 60, the transfer press transfers the forged workpiece 33a to the hole forming step 70 illustrated in FIG. 15.

In the hole forming step 70, two mounting holes 3a and 3b, each having a diameter of 14 mm, are formed in the mounting portion 3 of the forged workpiece 33a. The mounting holes 3a and 3b are used to attach the door hinge to an automobile body. The mounting hole 3a is formed in a thin end portion of the mounting portion 3, and the mounting hole 3b is formed in a middle portion of the mounting portion 3.

In the hole forming step 70, a hole cutting punch 71 having two cylindrical portions 71a each having an outside diameter of 14 mm, and a hole die 72 having two holes 72a each having a diameter of 14 mm are used.

After the hole forming step 70, the process of manufacturing the body-side door hinge 1a according to the first embodiment is finished.

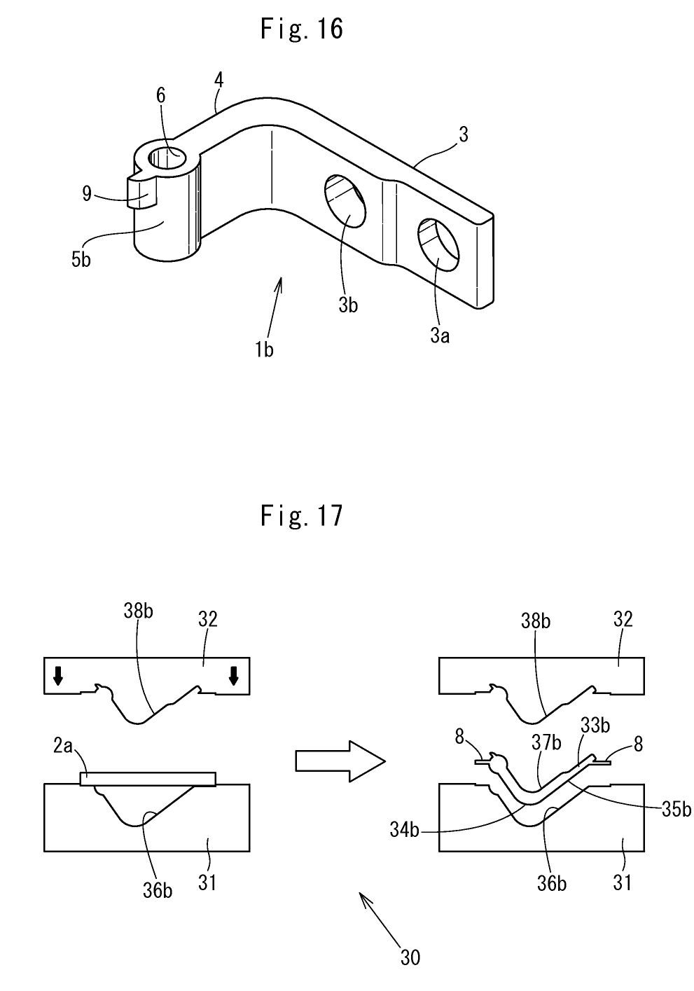

Next, referring to FIGS. 16 to 20, a method of manufacturing an automobile door hinge according to a second embodiment of the present invention will be described.

The method of manufacturing an automobile door hinge according to the second embodiment differs from that of the first embodiment in a part of the structure of the body-side door hinge 1a.

To be specific, the structure of a body-side door hinge according to the second embodiment differs from that of the first embodiment in the following respect. That is, in the body-side door hinge according to the second embodiment, the mounting portion, the arm portion, and the engagement portion have the same height; the arm portion does not have a stopper; and the engagement portion is a protrusion-including engagement portion having a door stop protrusion on a distal side the cylindrical shape of the engagement portion.

FIG. 16 illustrates a body-side door hinge 1b, which is to be attached to an automobile body, made by the manufacturing method according to the second embodiment. As illustrated in FIG. 16, the body-side door hinge 1b includes a strip-shaped mounting portion 3, a strip-shaped arm portion 4 that is bent away from the mounting portion 3, and a protrusion-including engagement portion 5b that is disposed at an end of the arm portion 4 and that has a cylindrical shape. The protrusion-including engagement portion 5b has a shaft hole 6, into which a hinge pin is to be inserted, and a door stop protrusion 9 on a distal side of the cylindrical shape. Mounting holes 3a and 3b are formed in the mounting portion 3.

The mounting portion 3, the arm portion 4, and the protrusion-including engagement portion 5b of the body-side door hinge 1b have the same height. The door stop protrusion 9 is formed on an upper part of the protrusion-including engagement portion 5b having a length that is ⅓ of the height of the protrusion-including engagement portion 5b.

Hereinafter, the steps the same as those of the first embodiment will be denoted by the same numerals, and such steps will not be described or will be described simply.

Description of the outline of the manufacturing method according to the second embodiment will be omitted, because the outline is the same as that of the first embodiment, which is illustrated in FIG. 1. In the following description, the steps and the numerals used in the first embodiment will be used.

Description of a cutting step 20 and a heating step 25 of the second embodiment will be omitted, because they are the same as those of the first embodiment.

In a hot forging step 30 of the second embodiment, the structure of a forged workpiece 33b is different from that of the forged workpiece 33a of the first embodiment. Therefore, as illustrated in FIG. 17, the shape of a concave portion 36b in the lower die 31 is formed so as to receive a protruding surface 35b on a protruding side of a bent portion 34b of the forged workpiece 33b, and the shape of a convex portion 38b of the upper die 32 is formed so as to match the shape of an opposite surface 37b of the forged workpiece 33b opposite to the protruding surface 35b.

Description of the method of hot forging will be omitted, because it is the same as that of the first embodiment.

Description of a trimming step 40 and a cooling step 45 of the second embodiment will be omitted, because they are the same as those of the first embodiment.

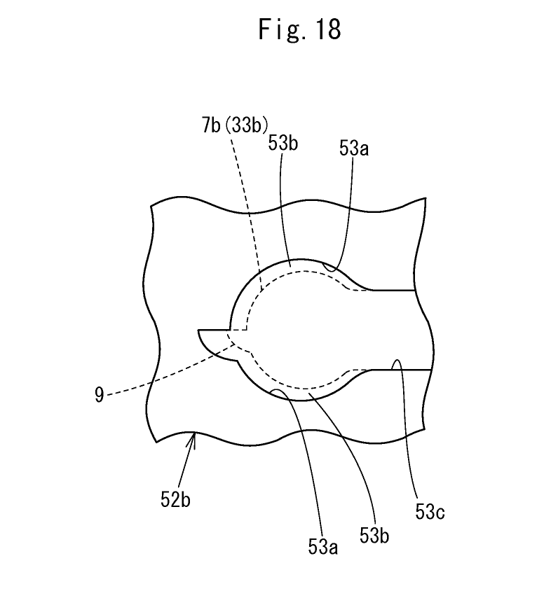

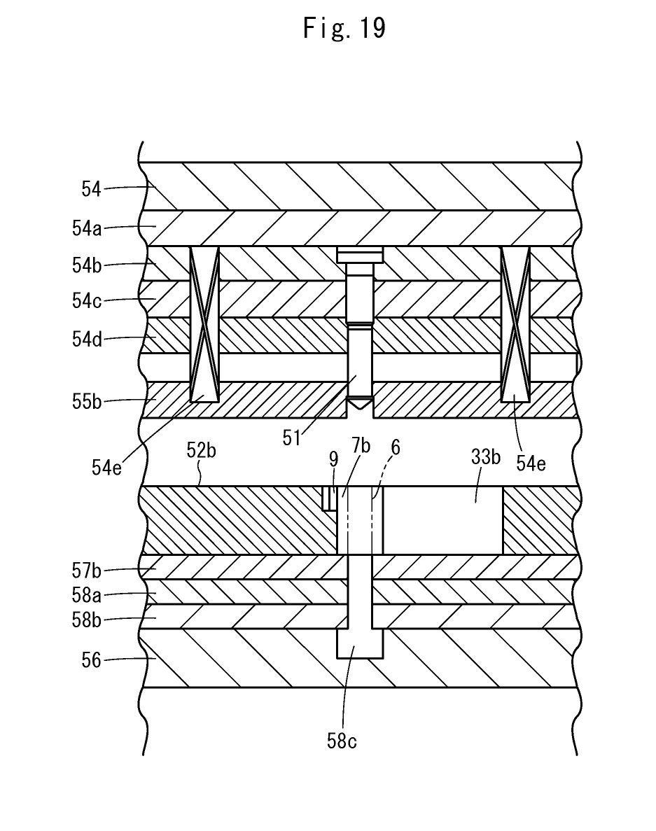

In a shaft hole forming step 50 of the second embodiment, the shape of the forged workpiece 33b is different from that of the first embodiment. Therefore, a first die 52b is formed so as to have a shape illustrated in FIG. 18, and part of the structure of upper and lower die sets is changed as illustrated in FIG. 19.

As illustrated in FIG. 18, the first die 52b has an inner side wall 53a that is separated from the outer periphery of a protrusion-including column portion 7b (shown by a dotted line) of the forged workpiece 33b with a gap therebetween. A gap volume 53b that is provided between the outer periphery of the protrusion-including column portion 7b and the inner side wall 53a has such a size that, during punching of the protrusion-including column portion 7b of the forged workpiece 33b using the first punch 51, which is the same as that of the first embodiment, a slug is not generated and the protrusion-including column portion 7b expands outward when the first punch 51 is pressed into the protrusion-including column portion 7b from a punching start point to a position at ⅘ of the length of the protrusion-including column portion 7b, and a slug is generated and discharged when the first punch 51 is pressed into the protrusion-including column portion 7b from the position at ⅘ of the length of the protrusion-including column portion 7b to a punching end point.

An inner side wall 53c of the first die 52b, which does not face the protrusion-including column portion 7b, has such a shape that the inner side wall 53c comes into contact with the outer peripheries of the mounting portion 3 and the arm portion 4 of the forged workpiece 33b without a gap therebetween. The protrusion-including column portion 7b of the forged workpiece 33b is positioned with respect to the inner side wall 53c.

By using the first punch 51, the first die 52b, and a transfer press having a capacity of 500 ton, the shaft hole 6 is formed in the axial center of the protrusion-including column portion 7b.

As illustrated in FIG. 19, the transfer press used in the shaft hole forming step has an upper die set 54, which moves up and down, and a lower die set 56, which is fixed to the transfer press. The first punch 51 is attached to the upper die set 54 using a punch plate 54a; punch holders 54b, 54c, and 54d; springs 54e; a stripper 55b; and the like. The first die 52b is attached to the lower die set 56 using a die holder 57b, die plates 58a and 58b, and the like.

Then, the forged workpiece 33b is inserted into the first die 52b. The upper die set 54 is lowered so that the stripper 55b of the upper die set 54 contacts the first die 52b. The forged workpiece 33b, excluding a portion in which the shaft hole 6 is to be formed, is vertically fixed between the stripper 55b and the die holder 57b using the springs 54e. Then, the shaft hole 6 is formed by lowering the first punch 51. When the first punch 51 is pressed into the protrusion-including column portion 7b from a punching start point to a position at ⅘ of the length of the protrusion-including column portion 7b, a slug is not generated and the protrusion-including column portion 7b expands outward so as to fill the gap volume 53b in the first die 52b. When the first punch 51 is pressed further into the protrusion-including column portion 7b from the position at ⅘ of the length of the protrusion-including column portion 7b to the punching end point, a slug is generated and discharged to the outside through a slug discharge hole 58c.

Next, the upper die set 54 is lifted to the initial position, a hydraulic device (not shown) pushes up the forged workpiece 33b, in which the shaft hole 6 has been formed, so as to remove the forged workpiece 33b from the first die 52b, thereby finishing the shaft hole forming step 50.

Thus, in the shaft hole forming step 50, the protrusion-including column portion 7b of the forged workpiece 33b is formed into the protrusion-including engagement portion 5b, which has a cylindrical shape having an inside diameter of 8.8 mm and a height of 24 mm.

After the shaft hole forming step 50, the forged workpiece 33b is turned upside down, and the shaft hole 6, which has been formed in the protrusion-including engagement portion 5b of the forged workpiece 33b, is finished in a shaft hole finishing step 60 by using the transfer press.

In the shaft hole finishing step 60, the shaft hole 6, which has been formed in the protrusion-including engagement portion 5b of the forged workpiece 33b in the shaft hole forming step 50, is finished with high precision by using a second die 62b and the second punch 61, which is the same as that of the first embodiment.

The second die 62b has an inner side wall having a shape the same as that of the first die 52b, excluding a portion of the inner side wall of the second die 62b that is located below the protrusion 9 of the forged workpiece 33b in the first die 52b.

Because the forged workpiece 33b is inserted into the first die 52b and the second die 62b in vertically opposite orientations, the first die 52b and the second die 62b have shapes that are vertically symmetric to each other.

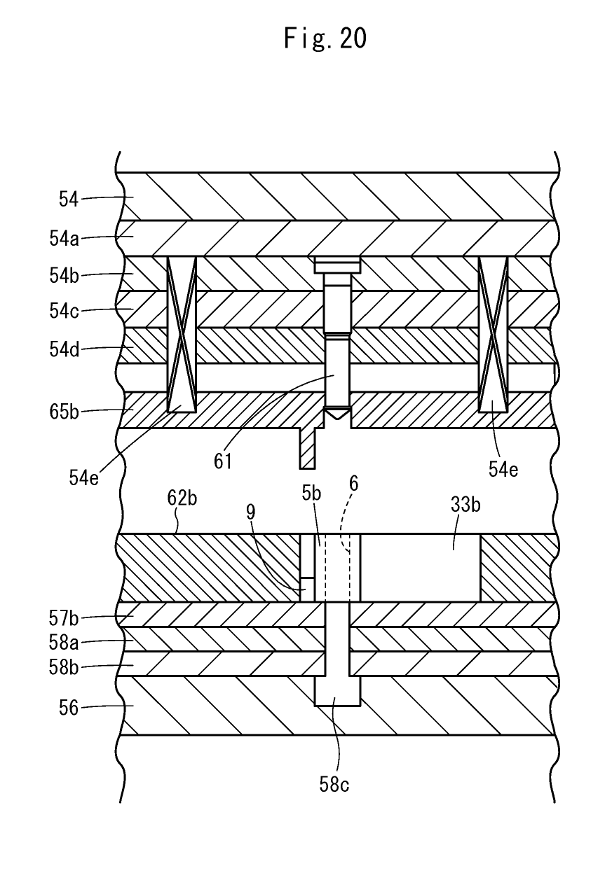

Also in the shaft hole finishing step 60, the transfer press used in the shaft hole forming step 50 is used. As illustrated in FIG. 20, the second punch 61 is attached to the upper die set 54, and the second die 62b is fixed to the lower die set 56.

The maximum diameter of the second punch 61 used in the shaft hole finishing step 60 is larger than the maximum diameter of the first punch 51 used in the shaft hole forming step 50 by 0.2 mm. The forged workpiece 33b cannot expand vertically due to the presence of the stripper 65b and the die holder 57b and cannot expand outward due to the presence of the second die 62b. Therefore, the diameter of the shaft hole 6 is increased by 0.2 mm in the shaft hole finishing step 60. At this time, excess metal does not become a slug but serves to compensate for a shear droop portion 6a (see FIG. 14), which is formed adjacent to a punching start point of the shaft hole forming step 50, or is absorbed in a small gap between the protrusion-including engagement portion 5b and the inner side wall of the second die 62b.

By using the second punch 61, the second die 62b, and a transfer press having a capacity of 500 ton, the shaft hole 6 having a diameter of about 8.8 mm, which has been formed in the protrusion-including engagement portion 5b, is finished so as to have a diameter of 9.0 mm.

Description of the shaft hole finishing step will be omitted, because it is the same as that of the first embodiment.

Description of the hole forming step 70 of the second embodiment will be omitted, because it is the same as that of the first embodiment.

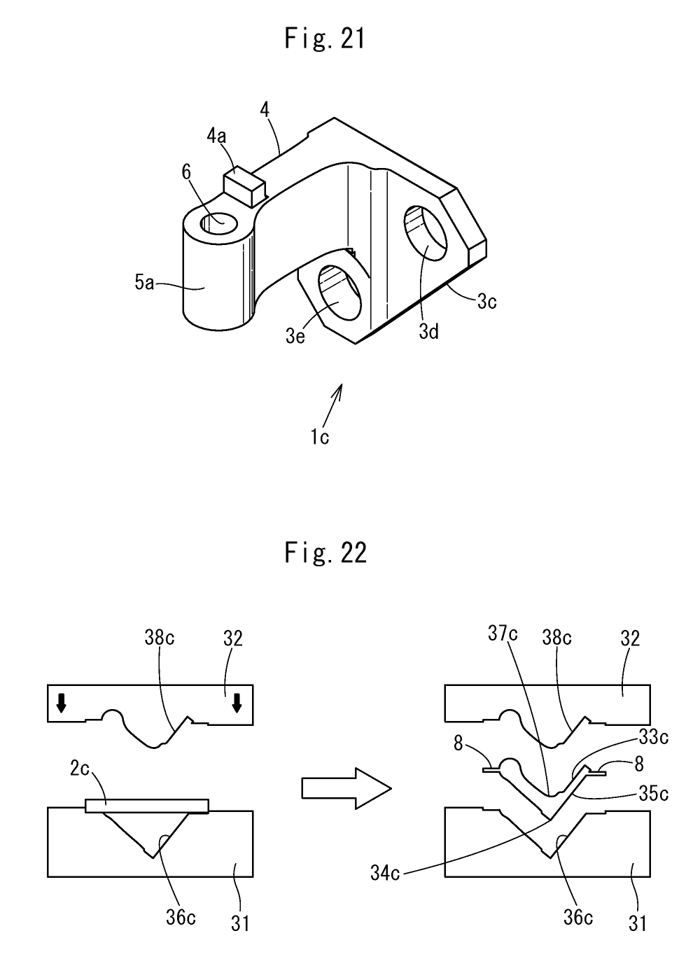

Next, referring to FIGS. 21 to 25, a method of manufacturing an automobile door hinge according to a third embodiment of the present invention will be described.

The method of manufacturing an automobile door hinge according to the third embodiment differs from that of the first embodiment in a part of the structure of the body-side door hinge 1a.

To be specific, the structure of a body-side door hinge according to the third embodiment differs from that of the first embodiment in that the body-side door hinge according to the third embodiment has a substantially right-triangular plate-like shape in a front view when it is in use.

FIG. 21 illustrates a body-side door hinge 1c, which is to be attached to an automobile body, made by the manufacturing method according to the third embodiment. As illustrated in FIG. 21, the body-side door hinge 1c includes a substantially right-triangular plate-like mounting portion 3c, a strip-shaped arm portion 4 that is bent away from the mounting portion 3c and that has a dimension smaller than the height dimension of the mounting portion 3c, and an engagement portion 5a formed at an end of the arm portion 4 and that has a cylindrical shape. The engagement portion 5a has a shaft hole 6, into which a hinge pin is to be inserted. A stopper 4a is formed on the arm portion 4, and mounting holes 3d and 3e are formed in the mounting portion 3c.

The body-side door hinge 1c according to the third embodiment has a horizontal dimension smaller than that of the body-side door hinge 1a according to the first embodiment and has a height dimension larger than that of the body-side door hinge 1a. Thus, the mounting hole 3d can be formed in an upper part of the mounting portion 3c and the mounting hole 3e can be formed in a lower part of the mounting portion 3c. Therefore, the body-side door hinge 1c can be attached to a portion of an automobile body having a small length in the horizontal direction.

Hereinafter, the steps the same as those of the first embodiment will be denoted by the same numerals and will not be described or will be described simply.

Description of the outline of the manufacturing method according to the third embodiment will be omitted, because the outline is the same as that of the first embodiment, which is illustrated in FIG. 1. In the following description, the steps and the numerals used in the first embodiment will be used.

In the third embodiment, the shape of the mounting portion 3c differs from that of the first embodiment. Therefore, a cutting step 20 of the third embodiment differs from that of the first embodiment in that a round steel bar used in the third embodiment has a diameter of 32 mm and a length of 70 mm, although it is a scale-covered S45c round steel bar as in the first embodiment. In other respects, the cutting step 20 is the same as that of the first embodiment.

Description of the heating step 25 will be omitted, because it is the same as that of the first embodiment.

In a hot forging step 30 of the third embodiment, the structure of a forged workpiece 33c is different from that of the forged workpiece 33a of the first embodiment. Therefore, as illustrated in FIG. 22, the shape of a concave portion 36c in the lower die 31 is formed so as to receive a protruding surface 35c on a protruding side of a bent portion 34c of the forged workpiece 33c, and the shape of a convex portion 38c of the upper die 32 is formed so as to match the shape of an opposite surface 37c of the forged workpiece 33c opposite to the protruding surface 35c.

Description of the method of hot forging will be omitted, because it is the same as that of the first embodiment.

Description of a trimming step 40 and a cooling step 45 of the third embodiment will be omitted, because they are the same as those of the first embodiment.

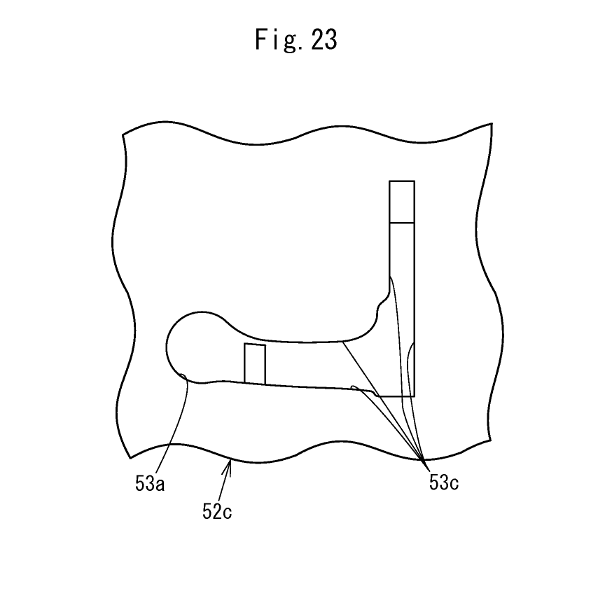

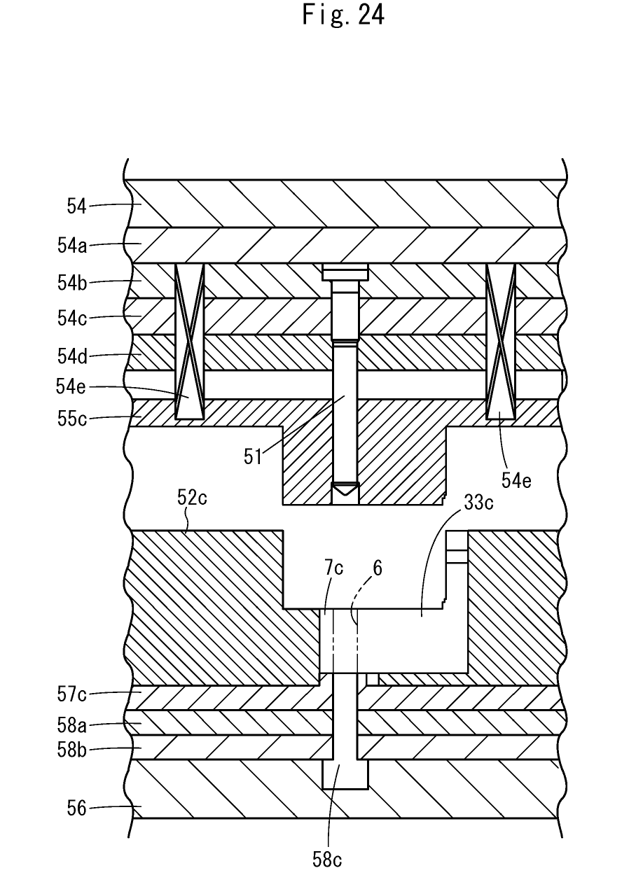

In a shaft hole forming step 50 of the third embodiment, the shape of the forged workpiece 33c is different from that of the first embodiment. Therefore, a first die 52c is formed so as to have a shape illustrated in FIG. 23, and part of the structure of upper and lower die sets is changed as illustrated in FIG. 24.

The enlarged partial plan view of a column portion 7c and the first die 52c of the third embodiment will be omitted, because it is the same as FIG. 9 for the first embodiment.

As illustrated in FIG. 23, the first die 52c has an inner side wall 53a that is separated from the outer periphery of the column portion 7c (not shown) of the forged workpiece 33c with a gap therebetween. A gap volume 53b between the outer periphery of the column portion 7c and the inner side wall 53a has such a size that, during punching of the column portion 7c of the forged workpiece 33c using the first punch 51, which has a diameter the same as that of the first embodiment and which has a shaft portion 51c that is longer than that of the first embodiment, a slug is not generated and the column portion 7c expands outward when the first punch 51 is pressed into the column portion 7c from a punching start point to a position at ⅘ of the length of the column portion 7c, and a slug is generated and discharged when the first punch 51 is pressed into the column portion 7c from the position at ⅘ of the length of the column portion 7c to a punching end point.

The inner side wall 53c of the first die 52c, which does not face the column portion 7c, has such a shape that the inner side wall 53c comes into contact with the outer peripheries of the mounting portion 3c and the arm portion 4 of the forged workpiece 33c without a gap therebetween. The column portion 7c of the forged workpiece 33c is positioned with respect to the inner side wall 53c.

By using the first punch 51, the first die 52c, and a transfer press having a capacity of 500 ton, the shaft hole 6 is formed in the axial center of the column portion 7c.

As illustrated in FIG. 24, the transfer press used in the shaft hole forming step has an upper die set 54, which moves up and down, and a lower die set 56, which is fixed to the transfer press. The first punch 51 is attached to the upper die set 54 using a punch plate 54a; punch holders 54b, 54c, and 54d; springs 54e; a stripper 55c; and the like. The first die 52c is attached to the lower die set 56 using a die holder 57c, die plates 58a and 58b, and the like.

Then, the forged workpiece 33c is inserted into the first die 52c. The upper die set 54 is lowered so that the stripper 55c of the upper die set 54 contacts the first die 52c. The forged workpiece 33c, excluding a portion in which the shaft hole 6 is to be formed, is vertically fixed between the stripper 55c and the die holder 57c using the springs 54e. Then, the shaft hole 6 is formed by lowering the first punch 51. When the first punch 51 is pressed into the column portion 7c from a punching start point to a position at ⅘ of the length of the column portion 7c, a slug is not generated and the column portion 7c expands outward so as to fill the gap volume 53b in the first die 52c. When the first punch 51 is pressed further into the column portion 7c from the position at ⅘ of the length of the column portion 7c to the punching end point, a slug is generated and discharged to the outside through a slug discharge hole 58c.

Next, the upper die set 54 is lifted to the initial position, a hydraulic device (not shown) pushes up the forged workpiece 33c, in which the shaft hole 6 has been formed, so as to remove the forged workpiece 33c from the first die 52c, thereby finishing the shaft hole forming step 50.

Thus, in the shaft hole forming step 50, the column portion 7c of the forged workpiece 33c is formed into an engagement portion 5c, which has a cylindrical shape having an inside diameter of 8.8 mm and a height of 24 mm.

After the shaft hole forming step 50, the forged workpiece 33c is turned upside down, and the shaft hole 6, which has been formed in the engagement portion 5c of the forged workpiece 33c, is finished in a shaft hole finishing step 60 by using the transfer press.

In the shaft hole finishing step 60, the shaft hole 6, which has been formed in the engagement portion 5c of the forged workpiece 33c in the shaft hole forming step 50, is finished with high precision by using a second die 62c and the second punch 61, which is the same as that of the first embodiment.

The second die 62c has an inner side wall having a shape the same as that of the first die 52c.

Because the forged workpiece 33c is inserted into the first die 52c and the second die 62c in vertically opposite orientations, the first die 52c and the second die 62c have shapes that are vertically symmetric to each other.

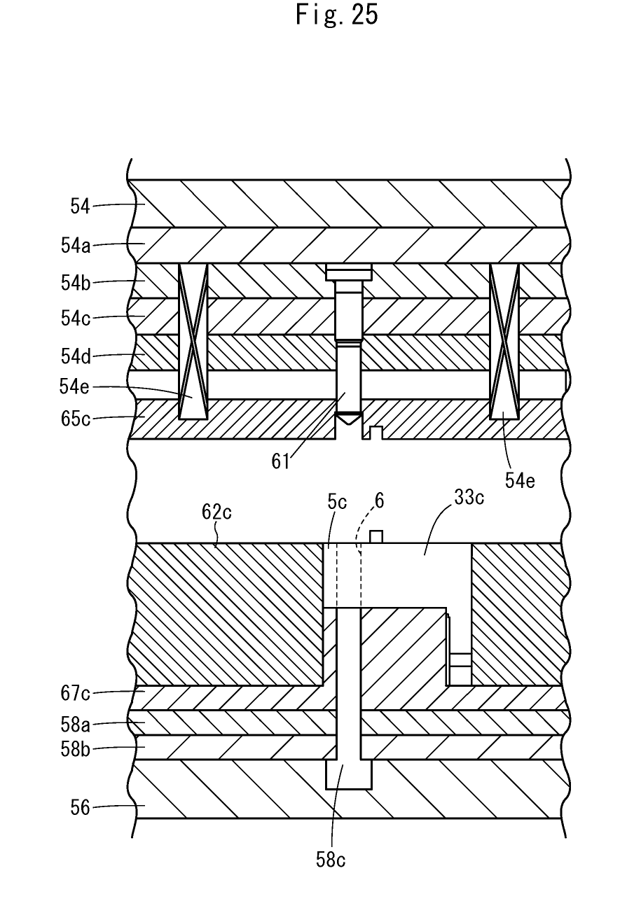

Also in the shaft hole finishing step 60, the transfer press used in the shaft hole forming step 50 is used. As illustrated in FIG. 25, the second punch 61 is attached to the upper die set 54, and the second die 62c is fixed to the lower die set 56.

The maximum diameter of the second punch 61 used in the shaft hole finishing step 60 is larger than the maximum diameter of the first punch 51 used in the shaft hole forming step 50 by 0.2 mm. The forged workpiece 33c cannot expand vertically due to the presence of the stripper 65c and the die holder 67c and cannot expand outward due to the presence of the second die 62c. Therefore, the diameter of the shaft hole 6 is increased by 0.2 mm in the shaft hole finishing step 60. At this time, excess metal does not become a slug but serves to compensate for a shear droop portion 6a (see FIG. 14), which is formed adjacent to a punching start point of the shaft hole forming step 50, or is absorbed in a small gap between the engagement portion 5c and the inner side wall of the second die 62c.

By using the second punch 61, the second die 62c, and a transfer press having a capacity of 500 ton, the shaft hole 6 having a diameter of about 8.8 mm, which has been formed in the engagement portion 5c, is finished so as to have a diameter of 9.0 mm.

Description of the shaft hole finishing step will be omitted, because it is the same as that of the first embodiment.

Description of the hole forming step 70 of the third embodiment will be omitted, because it is the same as that of the first embodiment.

Next, referring to FIGS. 26 to 30, a method of manufacturing an automobile door hinge according to a fourth embodiment of the present invention will be described.

The method of manufacturing an automobile door hinge according to the fourth embodiment differs from that of the third embodiment in a part of the structure of the body-side door hinge 1c.

To be specific, the structure of a body-side door hinge according to the fourth embodiment differs from that of the third embodiment in that the body-side door hinge according to the fourth embodiment does not have the stopper, which is disposed on the arm portion of the third embodiment, and the engagement portion is a protrusion-including engagement portion having a door stop protrusion on a distal side of the cylindrical shape of the engagement portion.

FIG. 26 illustrates a body-side door hinge 1d, which is to be attached to an automobile body, made by the manufacturing method according to the fourth embodiment. As illustrated in FIG. 26, the body-side door hinge 1d includes a substantially right-triangular plate-like mounting portion 3c, a strip-shaped arm portion 4 that is bent away from the mounting portion 3c and that has a dimension smaller than the height dimension of the mounting portion 3c, and a protrusion-including engagement portion 5b that is disposed at an end of the arm portion 4 and that has a cylindrical shape. The protrusion-including engagement portion 5b has a shaft hole 6, into which a hinge pin is to be inserted, and a door stop protrusion 9 on a distal side of the cylindrical shape. Mounting holes 3d and 3e are formed in the mounting portion 3c.

The mounting portion 3c, the arm portion 4, and the protrusion-including engagement portion 5b of the body-side door hinge 1d have the same height. The door stop protrusion 9 is formed on an upper part of the protrusion-including engagement portion 5b having a length that is ⅓ of the height of the protrusion-including engagement portion 5b.

Hereinafter, the steps the same as those of the third embodiment will be denoted by the same numerals and will not be described or will be described simply.

Description of the outline of the manufacturing method according to the fourth embodiment will be omitted, because the outline is the same as that of the third (first) embodiment, which is illustrated in FIG. 1. In the following description, the steps and the numerals used in the third (first) embodiment will be used.

Description of a cutting step 20 and a heating step 25 of the fourth embodiment will be omitted, because they are the same as those of the third (first) embodiment.

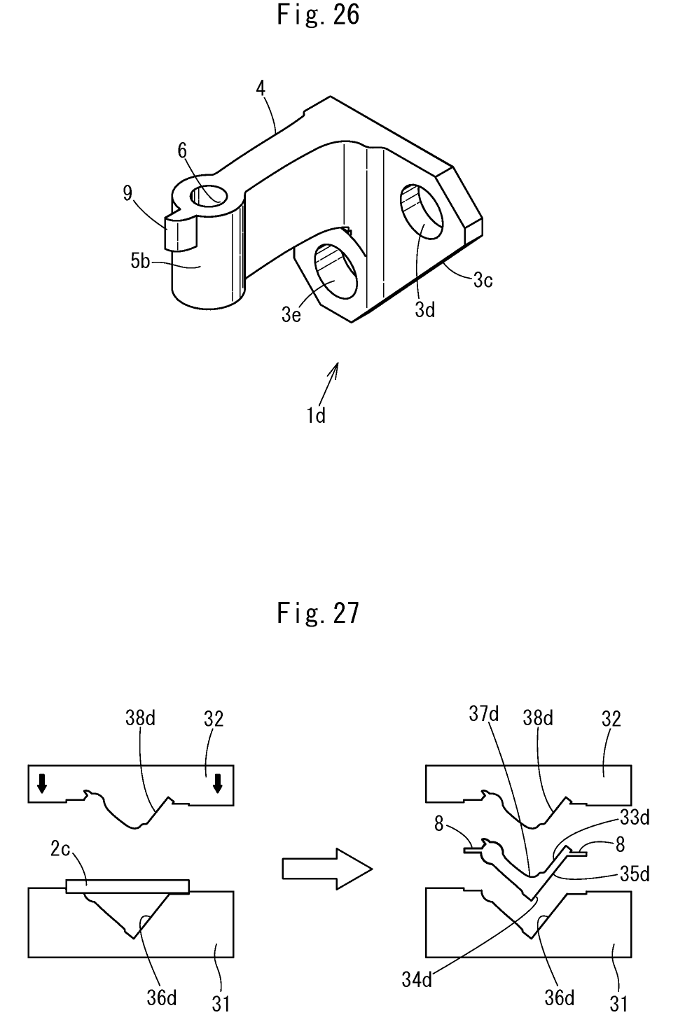

In a hot forging step 30 of the fourth embodiment, the structure of a forged workpiece 33d is different from that of the forged workpiece 33c of the third embodiment. Therefore, as illustrated in FIG. 27, the shape of a concave portion 36d in the lower die 31 is formed so as to receive a protruding surface 35d on a protruding side of a bent portion 34d of the forged workpiece 33d, and the shape of a convex portion 38d of the upper die 32 is formed so as to match the shape of an opposite surface 37d of the forged workpiece 33d opposite to the protruding surface 35d.

Description of the method of hot forging will be omitted, because it is the same as that of the third (first) embodiment.

Description of a trimming step 40 and a cooling step 45 of the fourth embodiment will be omitted, because they are the same as those of the third (first) embodiment.

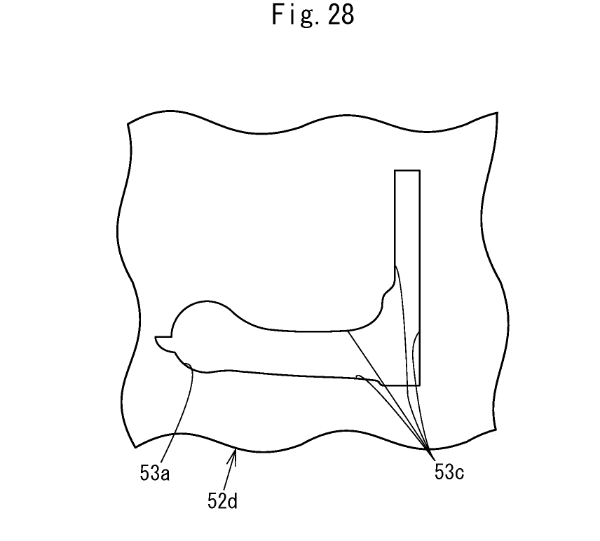

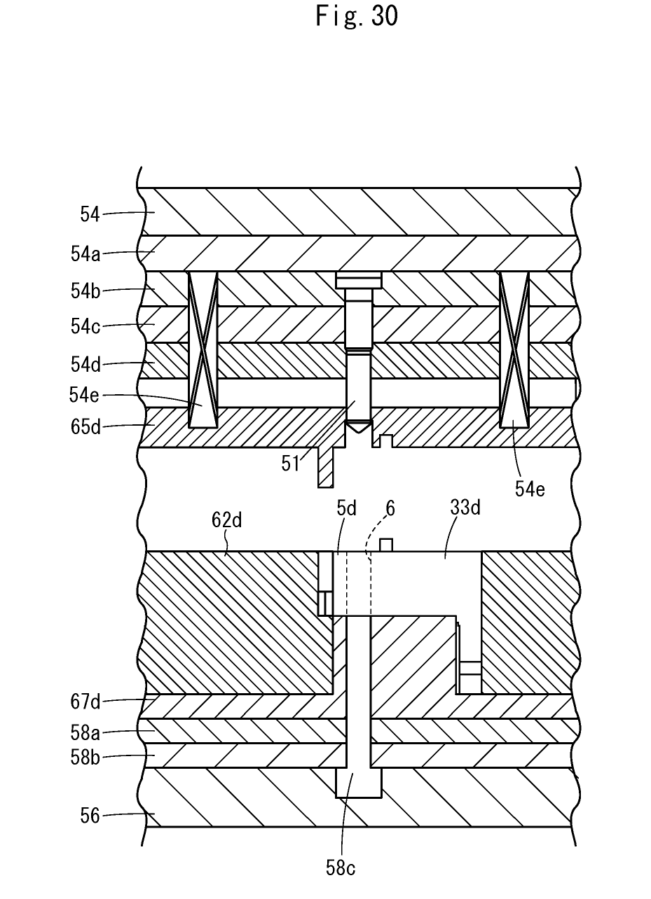

In a shaft hole forming step 50 of the fourth embodiment, the shape of the forged workpiece 33d is different from that of the third embodiment. Therefore, a first die 52d is formed so as to have a shape illustrated in FIG. 28, and part of the structure of upper and lower die sets is changed as illustrated in FIG. 30.

As illustrated in FIG. 18 for the second embodiment, the first die 52d has an inner side wall 53a that is separated from a protrusion-including column portion 7b (shown by a dotted line) of the forged workpiece 33d with a gap therebetween. A gap volume 53b between the outer periphery of the protrusion-including column portion 7b and the inner side wall 53a has such a size that, during punching of the protrusion-including column portion 7b of the forged workpiece 33d using the first punch 51, which has a diameter the same as that of the first embodiment and has a shaft portion 51c that is longer than that of the first embodiment, a slug is not generated and the protrusion-including column portion 7b expands outward when the first punch 51 is pressed into the protrusion-including column portion 7b from a punching start point to a position at ⅘ of the length of the protrusion-including column portion 7b, and a slug is generated and discharged when the first punch 51 is pressed into the protrusion-including column portion 7b from the position at ⅘ of the length of the protrusion-including column portion 7b to a punching end point.

The inner side wall 53c of the first die 52d, which does not face the protrusion-including column portion 7b, has such a shape that the inner side wall 53c comes into contact with the outer peripheries of the mounting portion 3c and the arm portion 4 of the forged workpiece 33d without a gap therebetween. The protrusion-including column portion 7b of the forged workpiece 33d is positioned with respect to the inner side wall 53c.

By using the first punch 51, the first die 52d, and a transfer press having a capacity of 500 ton, the shaft hole 6 is formed in the axial center of the protrusion-including column portion 7b.

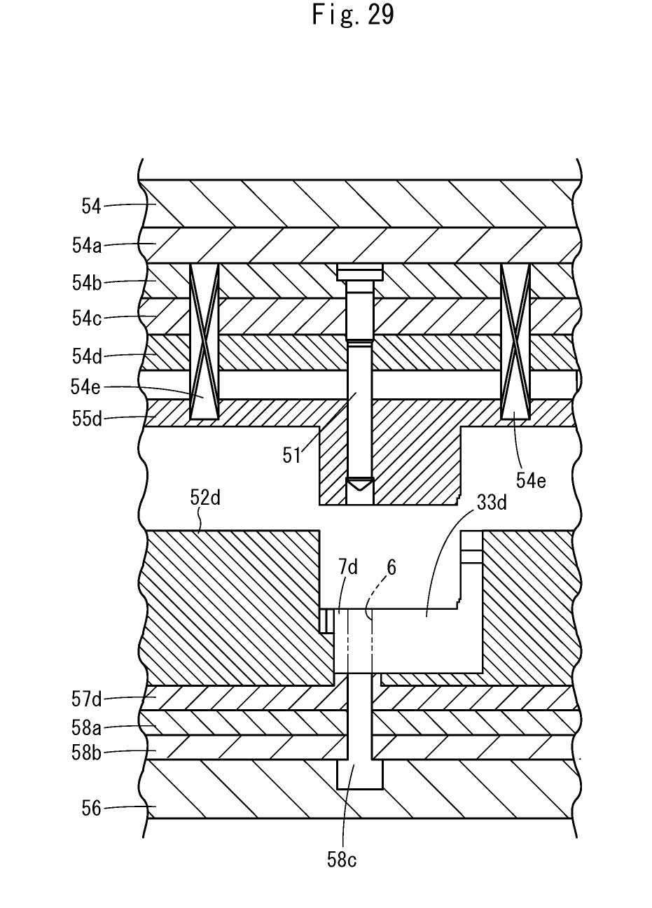

As illustrated in FIG. 29, the transfer press used in the shaft hole forming step has an upper die set 54, which moves up and down, and a lower die set 56, which is fixed to the transfer press. The first punch 51 is attached to the upper die set 54 using a punch plate 54a; punch holders 54b, 54c, and 54d; springs 54e; a stripper 55d; and the like. The first die 52d is attached to the lower die set 56 using a die holder 57d, die plates 58a and 58b, and the like.

Then, the forged workpiece 33d is inserted into the first die 52d. The upper die set 54 is lowered so that the stripper 55d of the upper die set 54 contacts the first die 52d. The forged workpiece 33d, excluding a portion in which the shaft hole 6 is to be formed, is vertically fixed between the stripper 55d and the die holder 57d using the springs 54e. Then, the shaft hole 6 is formed by lowering the first punch 51. When the first punch 51 is pressed into the protrusion-including column portion 7b from a punching start point to a position at ⅘ of the length of the protrusion-including column portion 7b, a slug is not generated and the protrusion-including column portion 7b expands outward so as to fill the gap volume 53b in the first die 52d. When the first punch 51 is pressed further into the protrusion-including column portion 7b from the position at ⅘ of the length of the protrusion-including column portion 7b to the punching end point, a slug is generated and discharged to the outside through a slug discharge hole 58c.

Next, the upper die set 54 is lifted to the initial position, a hydraulic device (not shown) pushes up the forged workpiece 33d, in which the shaft hole 6 has been formed, so as to remove the forged workpiece 33d from the first die 52d, thereby finishing the shaft hole forming step 50.

Thus, in the shaft hole forming step 50, the protrusion-including column portion 7b of the forged workpiece 33d is formed into the protrusion-including engagement portion 5b having an inside diameter of 8.8 mm and a height of 24 mm.

After the shaft hole forming step 50, the forged workpiece 33d is turned upside down, and the shaft hole 6, which has been formed in the protrusion-including engagement portion 5b of the forged workpiece 33d, is finished in a shaft hole finishing step 60 by using the transfer press.

In the shaft hole finishing step 60, the shaft hole 6, which has been formed in the protrusion-including engagement portion 5b of the forged workpiece 33d in the shaft hole forming step 50, is finished with high precision by using a second die 62d and the second punch 61, which is the same as that of the first embodiment.

The second die 62d has an inner side wall having a shape the same as that of the first die 52d, excluding a portion of the inner side wall of the second die 62d that is located below the protrusion 9 of the forged workpiece 33d in the first die 52d.

Because the forged workpiece 33d is inserted into the first die 52d and the second die 62d in vertically opposite orientations, the first die 52d and the second die 62d have shapes that are vertically symmetric to each other.

Also in the shaft hole finishing step 60, the transfer press used in the shaft hole forming step 50 is used. As illustrated in FIG. 30, the second punch 61 is attached to the upper die set 54, and the second die 62d is fixed to the lower die set 56.

The maximum diameter of the second punch 61 used in the shaft hole finishing step 60 is larger than the maximum diameter of the first punch 51 used in the shaft hole forming step 50 by 0.2 mm. The forged workpiece 33d cannot expand vertically due to the presence of the stripper 65d and the die holder 67d and cannot expand outward due to the presence of the second die 62d. Therefore, the diameter of the shaft hole 6 is increased by 0.2 mm in the shaft hole finishing step 60. At this time, excess metal does not become a slug but serves to compensate for a shear droop portion 6a (see FIG. 14), which is formed adjacent to a punching start point of the shaft hole forming step 50, or is absorbed in a small gap between the protrusion-including engagement portion 5b and the inner side wall of the second die 62d.

By using the second punch 61, the second die 62d, and a transfer press having a capacity of 500 ton, the shaft hole 6 having a diameter of about 8.8 mm, which has been formed in the protrusion-including engagement portion 5b, is finished so as to have a diameter of 9.0 mm.

Description of the shaft hole finishing step will be omitted, because it is the same as that of the third (first) embodiment.

Description of the hole forming step 70 of the fourth embodiment will be omitted, because it is the same as that of the third (first) embodiment.

In the third and fourth embodiments, the mounting portion 3c has a substantially right-triangular shape in front view when it is in use. Alternatively, the mounting portion 3c may have a polygonal shape, such as a rectangular or pentagonal shape.

Next, referring to FIGS. 31 to 36, a method of manufacturing an automobile door hinge according to a fifth embodiment of the present invention will be described.

The method of manufacturing an automobile door hinge according to the fifth embodiment is related to a door-side door hinge, which is to be attached to a door, whereas the methods of manufacturing an automobile door hinge according to the first to fourth embodiments is related to a body-side door hinge.

The structure of the door-side door hinge according to the fifth embodiment differs from the body-side door hinge according to first or third embodiment in the following respects: the door-side door hinge according to the fifth embodiment has a door stop protrusion on an engagement portion, whereas the body-side door hinge according to the first or third embodiment does not have a door stop protrusion but has an arm portion having a stopper; and the door-side door hinge has a small size due to limitation on a mounting space, does not have an arm portion, and has only one mounting hole.

FIG. 31 illustrates a door-side door hinge 1e made by the manufacturing method according to the fifth embodiment, which is to be attached to a door. As illustrated in FIG. 31, the door-side door hinge 1e includes a strip-shaped mounting portion 3f and a protrusion-including engagement portion 5e that is disposed in a portion bent away from the mounting portion 3f and that has a cylindrical shape. The protrusion-including engagement portion 5e has a shaft hole 6, into which a hinge pin is to be inserted, and a door stop protrusion 9 on a distal side of the cylindrical shape. A mounting hole 3g is formed in the mounting portion 3f.

In the door-side door hinge 1e, the height dimension of the protrusion-including engagement portion 5e is smaller than that of the mounting portion 3f. The height of the protrusion 9 is substantially the same as that of the protrusion-including engagement portion 5e.

Hereinafter, the steps the same as those of the first embodiment will be denoted by the same numerals and will not be described or will be described simply.

Description of the outline of the manufacturing method according to the fifth embodiment will be omitted, because the outline is the same as that of the first embodiment, which is illustrated in FIG. 1. In the following description, the steps and the numerals used in the first embodiment will be used.

In the fifth embodiment, the size of a forged workpiece 33e formed in a hot forging step 30 is small. Therefore, a cutting step 20 of the fifth embodiment differs from that of the first embodiment in that a round steel bar used in the fifth embodiment has a diameter of 26 mm and a length of 52 mm, although it is a scale-covered S45c round steel bar as in the first embodiment. In other respects, the cutting step 20 is the same as that of the first embodiment.

Description of a heating step 25 will be omitted, because it is the same as that of the first embodiment.

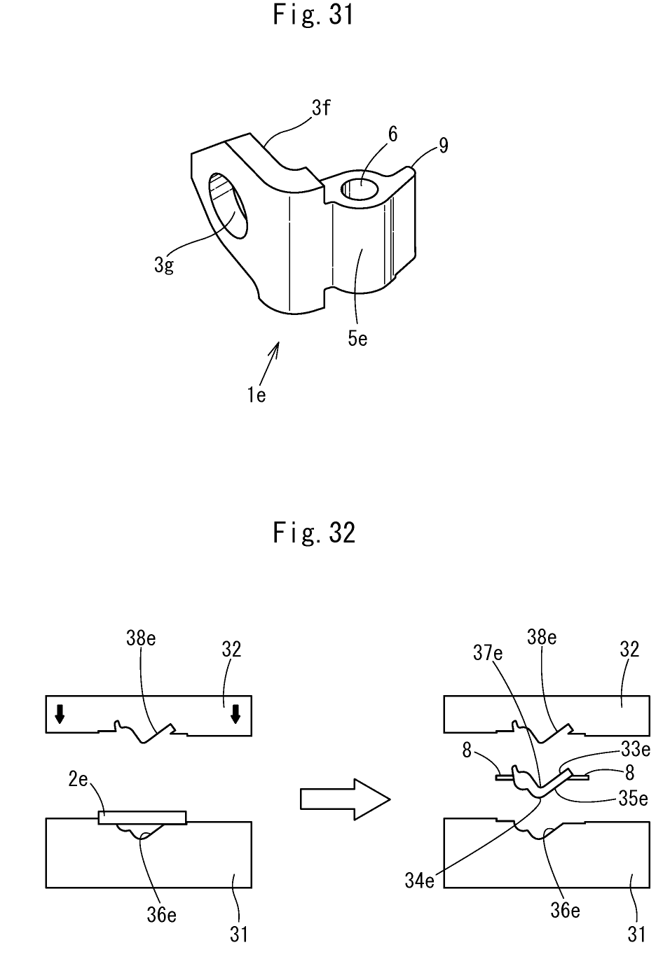

In the hot forging step 30 of the fifth embodiment, the structure of the forged workpiece 33e is different from that of the forged workpiece 33a of the first embodiment. Therefore, as illustrated in FIG. 32, the shape of a concave portion 36e in the lower die 31 is formed so as to receive a protruding surface 35e on a protruding side of a bent portion 34e of the forged workpiece 33e, and the shape of a convex portion 38e of the upper die 32 is formed so as to match the shape of an opposite surface 37e of the forged workpiece 33e opposite to the protruding surface 35e.

Description of the method of hot forging will be omitted, because it is the same as that of the first embodiment.

Description of a trimming step 40 and a cooling step 45 of the fifth embodiment will be omitted, because they are the same as those of the first embodiment.

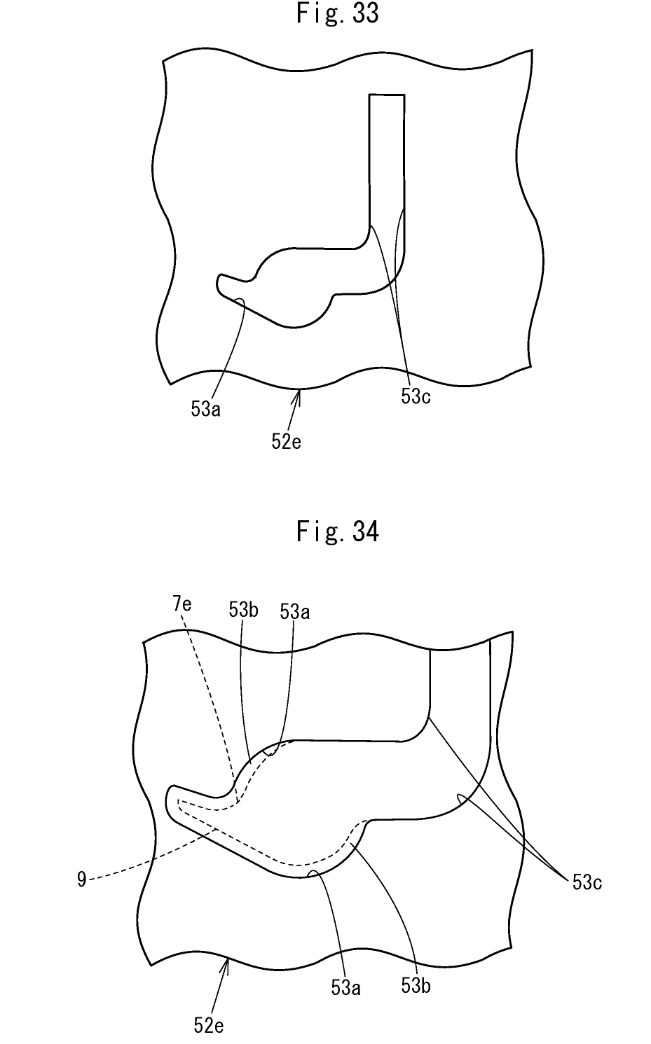

In a shaft hole forming step 50 of the fifth embodiment, the shape of the forged workpiece 33e is different from that of the first embodiment. Therefore, a first die 52e is formed so as to have a shape illustrated in FIG. 33, and part of the structure of upper and lower die sets is changed as illustrated in FIG. 35.

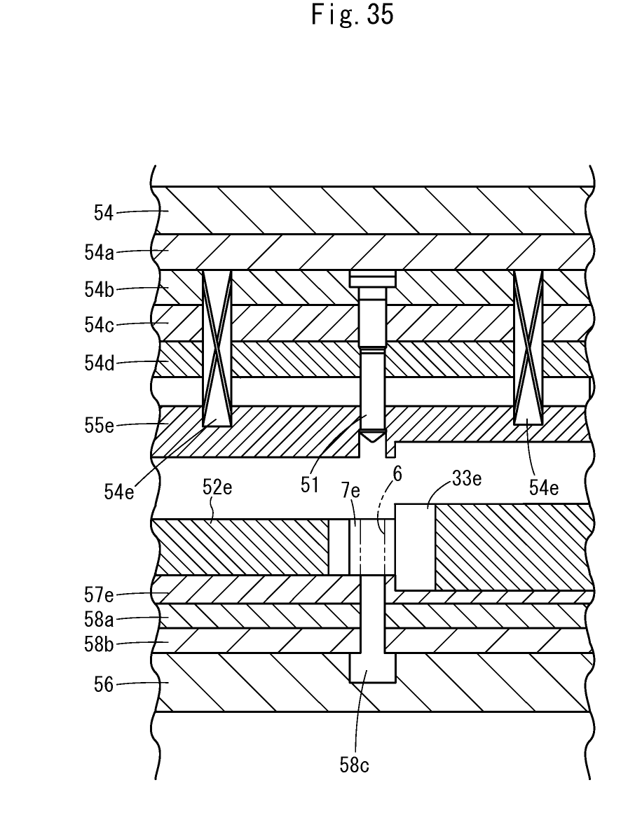

As illustrated in FIGS. 33 and 34, the first die 52e has an inner side wall 53a that is separated from a protrusion-including column portion 7e (shown by a dotted line) of the forged workpiece 33e with a gap therebetween. A gap volume 53b between the outer periphery of the protrusion-including column portion 7e and the inner side wall 53a has such a size that, during punching of the protrusion-including column portion 7e of the forged workpiece 33e using the first punch 51, which is the same as that of the first embodiment, a slug is not generated and the protrusion-including column portion 7e expands outward when the first punch 51 is pressed into the protrusion-including column portion 7e from a punching start point to a position at ⅘ of the length of the protrusion-including column portion 7e, and a slug is generated and discharged when the first punch 51 is pressed into the protrusion-including column portion 7e from the position at ⅘ of the length of the protrusion-including column portion 7e to a punching end point.

The inner side wall 53c of the first die 52e, which does not face the protrusion-including column portion 7e, has such a shape that the inner side wall 53c comes into contact with the outer periphery of the mounting portion 3f of the forged workpiece 33e without a gap therebetween. The protrusion-including column portion 7e of the forged workpiece 33e is positioned with respect to the inner side wall 53c.

By using the first punch 51, the first die 52e, and a transfer press having a capacity of 500 ton, the shaft hole 6 is formed in the axial center of the protrusion-including column portion 7e.

As illustrated in FIG. 35, the transfer press used in the shaft hole forming step has an upper die set 54, which moves up and down, and a lower die set 56, which is fixed to the transfer press. The first punch 51 is attached to the upper die set 54 using a punch plate 54a; punch holders 54b, 54c, and 54d; springs 54e; a stripper 55e; and the like. The first die 52e is attached to the lower die set 56 using a die holder 57e, die plates 58a and 58b, and the like.

Then, the forged workpiece 33e is inserted into the first die 52e. The upper die set 54 is lowered so that the stripper 55e of the upper die set 54 contacts the first die 52e. The forged workpiece 33e, excluding a portion in which the shaft hole 6 is to be formed, is vertically fixed between the stripper 55e and the die holder 57e using the springs 54e. Then, the shaft hole 6 is formed by lowering the first punch 51. When the first punch 51 is pressed into the protrusion-including column portion 7e from a punching start point to a position at ⅘ of the length of the protrusion-including column portion 7e, a slug is not generated and the protrusion-including column portion 7e expands outward so as to fill the gap volume 53b in the first die 52e. When the first punch 51 is pressed further into the protrusion-including column portion 7e from the position at ⅘ of the length of the protrusion-including column portion 7e to the punching end point, a slug is generated and discharged to the outside through a slug discharge hole 58c.

Next, the upper die set 54 is lifted to the initial position, a hydraulic device (not shown) pushes up the forged workpiece 33e, in which the shaft hole 6 has been formed, so as to remove the forged workpiece 33e from the first die 52e, thereby finishing the shaft hole forming step 50.

Thus, in the shaft hole forming step 50, the protrusion-including column portion 7e of the forged workpiece 33e is formed into the protrusion-including engagement portion 5e having an inside diameter of 8.8 mm and a height of 24 mm.

After the shaft hole forming step 50, the forged workpiece 33e is turned upside down, and the shaft hole 6, which has been formed in the protrusion-including engagement portion 5e of the forged workpiece 33e, is finished in a shaft hole finishing step 60 by using the transfer press.

In the shaft hole finishing step 60, the shaft hole 6, which has been formed in the protrusion-including engagement portion 5e of the forged workpiece 33e in the shaft hole forming step 50, is finished with high precision by using a second die 62e and the second punch 61, which is the same as that of the first embodiment.

The second die 62e has an inner side wall having a shape the same as that of the first die 52e.

Because the forged workpiece 33e is inserted into the first die 52e and the second die 62e in vertically opposite orientations, the first die 52e and the second die 62e have shapes that are vertically symmetric to each other.

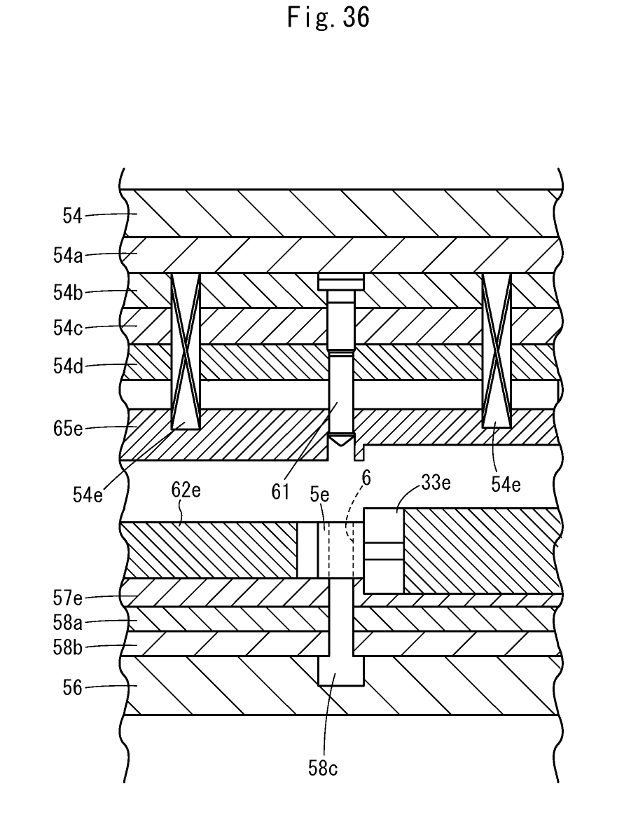

Also in the shaft hole finishing step 60, the transfer press used in the shaft hole forming step 50 is used. As illustrated in FIG. 36, the second punch 61 is attached to the upper die set 54, and the second die 62e is fixed to the lower die set 56.

The maximum diameter of the second punch 61 used in the shaft hole finishing step 60 is larger than the maximum diameter of the first punch 51 used in the shaft hole forming step 50 by 0.2 mm. The forged workpiece 33e cannot expand vertically due to the presence of the stripper 65e and the die holder 57e and cannot expand outward due to the presence of the second die 62e. Therefore, the diameter of the shaft hole 6 is increased by 0.2 mm in the shaft hole finishing step 60. At this time, excess metal does not become a slug but serves to compensate for a shear droop portion 6a (see FIG. 14), which is formed adjacent to a punching start point of the shaft hole forming step 50, or is absorbed in a small gap between the protrusion-including engagement portion 5e and the inner side wall of the second die 62e.

By using the second punch 61, the second die 62e, and a transfer press having a capacity of 500 ton, the shaft hole 6 having a diameter of about 8.8 mm, which has been formed in the protrusion-including engagement portion 5e, is finished so as to have a diameter of 9.0 mm.

Description of the shaft hole finishing step will be omitted, because it is the same as that of the first embodiment.

Description of the hole forming step 70 of the fifth embodiment will be omitted, because it is the same as that of the first embodiment.

Next, referring to FIGS. 37 to 42, a method of manufacturing an automobile door hinge according to a sixth embodiment of the present invention will be described.

The method of manufacturing an automobile door hinge according to the sixth embodiment differs from that of the fifth embodiment in a part of the structure of the door-side door hinge to be attached to a door.

To be specific, the structure of a door-side door hinge according to the sixth embodiment differs from that of the fifth embodiment in that the door-side door hinge according to the sixth embodiment has an engagement portion that does not have a protrusion, whereas the door-side door hinge according to the fifth embodiment has a protrusion-including engagement portion having a door stop protrusion.

FIG. 37 illustrates a door-side door hinge if made by the manufacturing method according to the sixth embodiment, which is to be attached to a door. As illustrated in FIG. 37, the door-side door hinge if includes a strip-shaped mounting portion 3f and an engagement portion 5f that is disposed in a portion bent away from the mounting portion 3f and that has a cylindrical shape. The engagement portion 5f has a shaft hole 6, into which a hinge pin is to be inserted. A mounting hole 3g is formed in the mounting portion 3f.

In the door-side door hinge 1f, the height dimension of the engagement portion 5f is smaller than that of the mounting portion 3f. An end portion of the mounting portion 3f on which the engagement portion 5f is not disposed serves as a stopper 3h.

Hereinafter, the steps the same as those of the fifth embodiment will be denoted by the same numerals and will not be described or will be described simply.

Description of the outline of the manufacturing method according to the sixth embodiment will be omitted, because the outline is the same as that of the fifth (first) embodiment, which is illustrated in FIG. 1. In the following description, the steps and the numerals used in the fifth (first) embodiment will be used.

Description of a cutting step 20 and a heating step 25 of the sixth embodiment will be omitted, because they are the same as those of the fifth (first) embodiment.

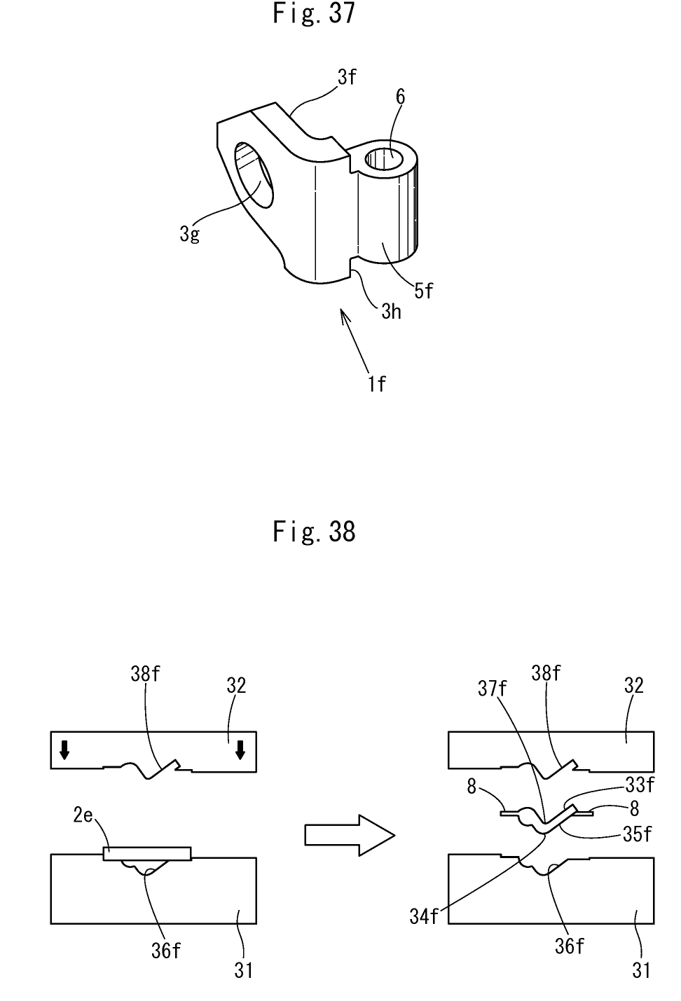

In the hot forging step 30 of the sixth embodiment, the structure of a forged workpiece 33f is different from that of the forged workpiece 33e of the fifth embodiment. Therefore, as illustrated in FIG. 38, the shape of a concave portion 36f in the lower die 31 is formed so as to receive a protruding surface 35f on a protruding side of a bent portion 34f of the forged workpiece 33f, and the shape of a convex portion 38f of the upper die 32 is formed so as to match the shape of an opposite surface 37f of the forged workpiece 33f opposite to the protruding surface 35f.

Description of the method of hot forging will be omitted, because it is the same as that of the fifth (first) embodiment.

Description of a trimming step 40 and a cooling step 45 of the sixth embodiment will be omitted, because they are the same as those of the fifth (first) embodiment.

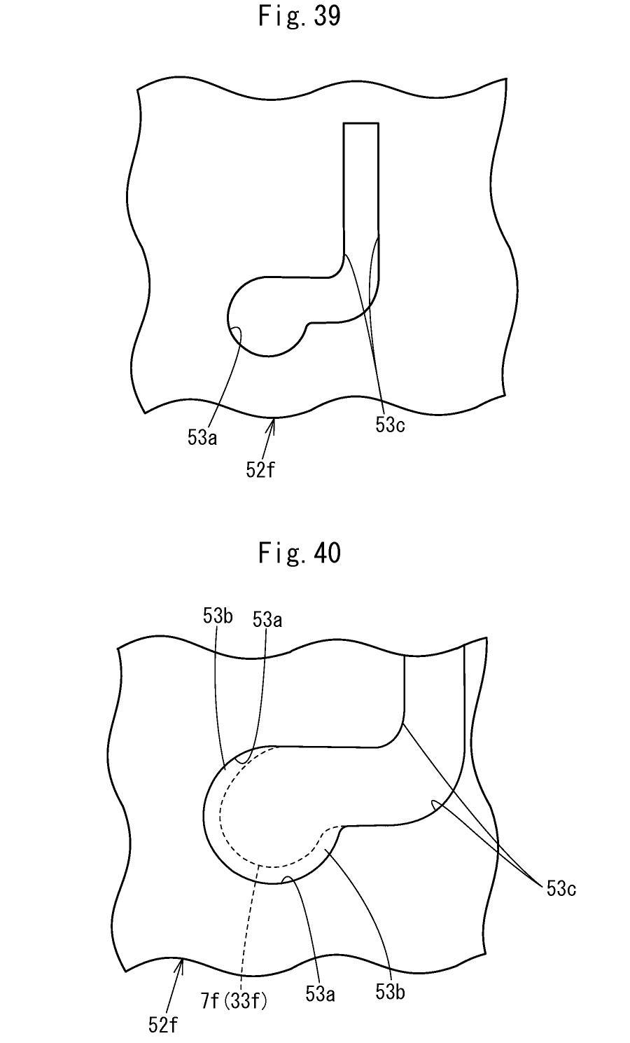

In a shaft hole forming step 50 of the sixth embodiment, the shape of the forged workpiece 33f is different from that of the fifth embodiment. Therefore, a first die 52f is formed so as to have a shape illustrated in FIG. 39, and part of the structure of upper and lower die sets is changed as illustrated in FIG. 41.

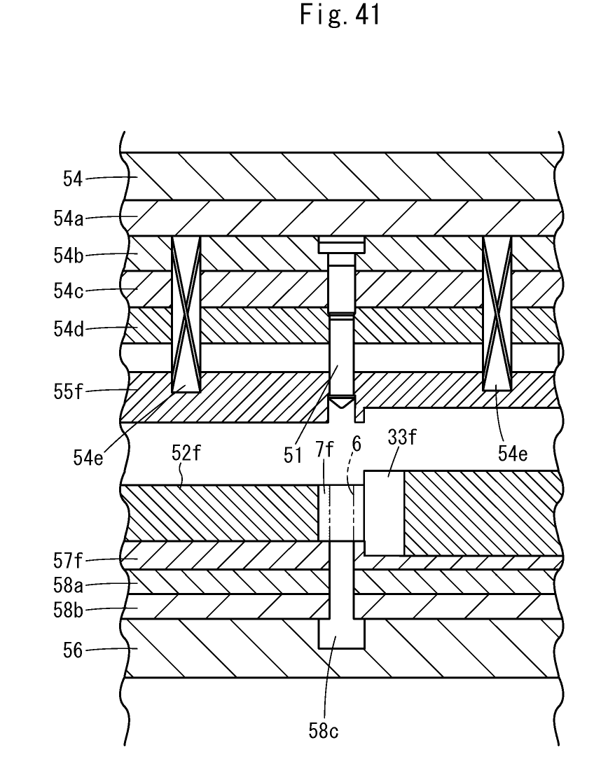

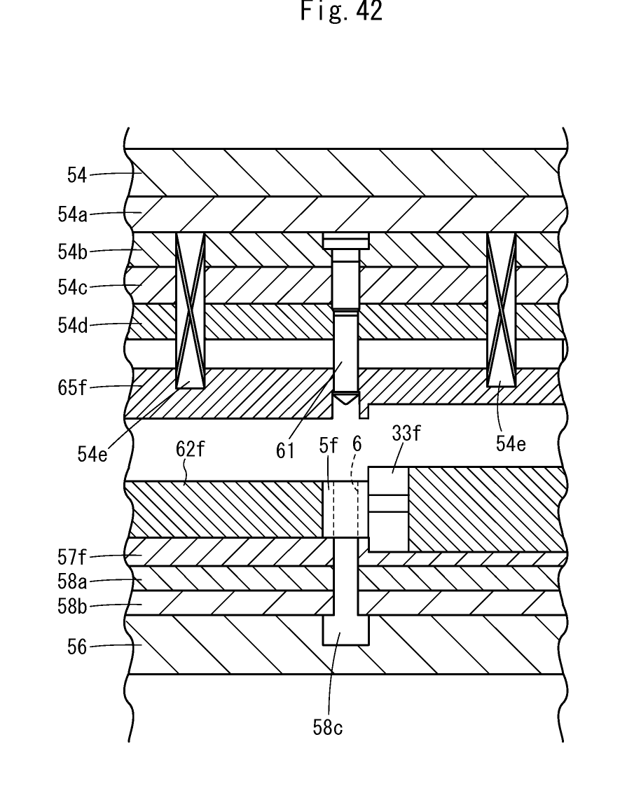

As illustrated in FIGS. 39 and 40, the first die 52f has an inner side wall 53a that is separated from a column portion 7f (shown by a dotted line) of the forged workpiece 33f with a gap therebetween. A gap volume 53b between the outer periphery of the column portion 7f and the inner side wall 53a has such a size that, during punching of the column portion 7f of the forged workpiece 33f using the first punch 51, which is the same as that of the first embodiment, a slug is not generated and the column portion 7f expands outward when the first punch 51 is pressed into the column portion 7f from a punching start point to a position at ⅘ of the length of the column portion 7f, and a slug is generated and discharged when the first punch 51 is pressed into the column portion 7f from the position at ⅘ of the length of the column portion 7f to a punching end point.

The inner side wall 53c of the first die 52f, which does not face the column portion 7f, has such a shape that the inner side wall 53c comes into contact with the outer periphery of the mounting portion 3f of the forged workpiece 33f without a gap therebetween. The column portion 7f of the forged workpiece 33f is positioned with respect to the inner side wall 53c.

By using the first punch 51, the first die 52f, and a transfer press having a capacity of 500 ton, the shaft hole 6 is formed in the axial center of the column portion 7f.

As illustrated in FIG. 41, the transfer press used in the shaft hole forming step has an upper die set 54, which moves up and down, and a lower die set 56, which is fixed to the transfer press. The first punch 51 is attached to the upper die set 54 using a punch plate 54a; punch holders 54b, 54c, and 54d; springs 54e; a stripper 55f; and the like. The first die 52f is attached to the lower die set 56 using a die holder 57f, die plates 58a and 58b, and the like.

Then, the forged workpiece 33f is inserted into the first die 52f. The upper die set 54 is lowered so that the stripper 55f of the upper die set 54 contacts the first die 52f. The forged workpiece 33f, excluding a portion in which the shaft hole 6 is to be formed, is vertically fixed between the stripper 55f and the die holder 57f using the springs 54e. Then, the shaft hole 6 is formed by lowering the first punch 51. When the first punch 51 is pressed into the column portion 7f from a punching start point to a position at ⅘ of the length of the column portion 7f, a slug is not generated and the column portion 7f expands outward so as to fill the gap volume 53b in the first die 52f. When the first punch 51 is pressed further into the column portion 7f from the position at ⅘ of the length of the column portion 7f to the punching end point, a slug is generated and discharged to the outside through a slug discharge hole 58c.

Next, the upper die set 54 is lifted to the initial position, a hydraulic device (not shown) pushes up the forged workpiece 33f, in which the shaft hole 6 has been formed, so as to remove the forged workpiece 33f from the first die 52f, thereby finishing the shaft hole forming step 50.

Thus, in the shaft hole forming step 50, the column portion 7f of the forged workpiece 33f is formed into the engagement portion 5f having an inside diameter of 8.8 mm and a height of 24 mm.

After the shaft hole forming step 50, the forged workpiece 33f is turned upside down, and the shaft hole 6, which has been formed in the engagement portion 5f of the forged workpiece 33f, is finished in a shaft hole finishing step 60 by using the transfer press.

In the shaft hole finishing step 60, the shaft hole 6, which has been formed in the engagement portion 5f of the forged workpiece 33f in the shaft hole forming step 50, is finished with high precision by using a second die 62f and the second punch 61, which is the same as that of the first embodiment.

The second die 62f has an inner side wall having a shape the same as that of the first die 52f.

Because the forged workpiece 33f is inserted into the first die 52f and the second die 62f in vertically opposite orientations, the first die 52f and the second die 62f have shapes that are vertically symmetric to each other.

Also in the shaft hole finishing step 60, the transfer press used in the shaft hole forming step 50 is used. As illustrated in FIG. 42, the second punch 61 is attached to the upper die set 54, and the second die 62f is fixed to the lower die set 56.

The maximum diameter of the second punch 61 used in the shaft hole finishing step 60 is larger than the maximum diameter of the first punch 51 used in the shaft hole forming step 50 by 0.2 mm. The forged workpiece 33f cannot expand vertically due to the presence of the stripper 65f and the die holder 57f and cannot expand outward due to the presence of the second die 62f. Therefore, the diameter of the shaft hole 6 is increased by 0.2 mm in the shaft hole finishing step 60. At this time, excess metal does not become a slug but serves to compensate for a shear droop portion 6a (see FIG. 14), which is formed adjacent to a punching start point of the shaft hole forming step 50, or is absorbed in a small gap between the engagement portion 5f and the inner side wall of the second die 62f.

By using the second punch 61, the second die 62f, and a transfer press having a capacity of 500 ton, the shaft hole 6 having a diameter of about 8.8 mm, which has been formed in the engagement portion 5f, is finished so as to have a diameter of 9.0 mm.

Description of the shaft hole finishing step will be omitted, because it is the same as that of the first embodiment.

Description of the hole forming step 70 of the sixth embodiment will be omitted, because it is the same as that of the fifth (first) embodiment.

The manufacturing methods according to the first to sixth embodiments each include the cutting step 20, the heating step 25, the hot forging step 30, the trimming step 40, the cooling step 45, the shaft hole forming step 50, the shaft hole finishing step 60, and the hole forming step 70. The inventions according to the first to sixth embodiments are characterized in the hot forging step, the shaft hole forming step, and the shaft hole finishing step. The cutting step, the heating step, the trimming step, the cooling step, and the hole forming step may be omitted or may be performed in other steps.

In the first to sixth embodiments, the temperature of the material used in the hot forging step 30 is increased to 1200° C.±50° C. in the heating step 25. Alternatively, this temperature may be in the range of 950° C. to 1350° C. If this temperature is lower than 950° C., a hot forging device (such as an air stamp hammer) needs to have a high capacity. If this temperature is higher than 1350° C., the forged workpiece becomes decarburized and has insufficient strength.

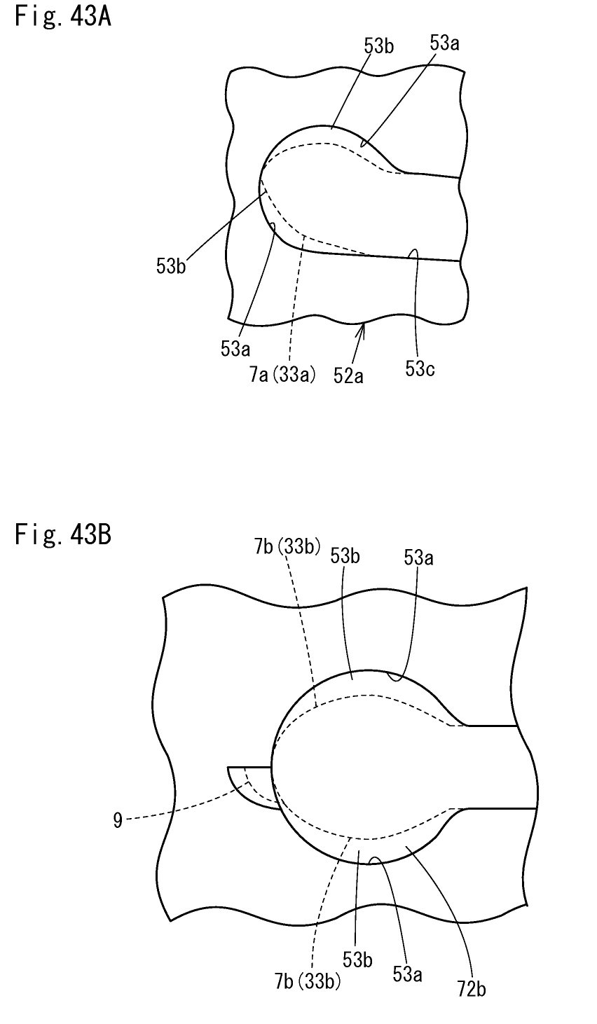

In the first to sixth embodiments, a column portion or a protrusion-including column portion having a circular horizontal cross section is formed in the hot forging step 30. Alternatively, as illustrated in FIGS. 43A and 43B, the column portion or the protrusion-including column portion may have an elliptical horizontal cross section.

FIG. 43A is an enlarged partial plan view, which corresponds to FIG. 9 of the first embodiment, illustrating a column portion 7a having an elliptical horizontal cross section and a first die 52a. FIG. 43B is an enlarged partial plan view, which corresponds to FIG. 18 of the second embodiment, illustrating a protrusion-including column portion 7b having an elliptical horizontal cross section and a first die 52b. Although not illustrated, in each of the third to sixth embodiments, the column portion or the protrusion-including column portion may have an elliptical horizontal cross section.

In the first to sixth embodiments, the trimming step 40 is performed after the hot forging step while the forged workpiece is hot. Alternatively, the trimming step 40 may be performed by warm working when the forged workpiece has a temperature in the range of 450° C. to 900° C. or may be performed by cold working after the cooling step 45. In a case where the trimming step is performed by warm working, the temperature of forged workpiece in the cooling step 45 is adjusted to be in the range of 450° C. to 900° C.

In the first to sixth embodiments, the tips of the first punch 51 and the second punch 61 each have a vertex angle of 90°. It is preferable that the vertex angle be in the range of 70° to 120°.

It is not preferable that the vertex angle of the first punch 51 be smaller than 70° because, in this case, excess metal in the shaft hole moves toward the outer periphery of the punch, so that a large stress is exerted on the punch and the punch may become broken.

It is not preferable that the vertex angle of the first punch 51 be larger than 120° because of the following reasons: a pushing force oriented forward into the shaft hole is exerted strongly and metal around the shaft hole is pulled in the direction in which the shaft hole extends, so that a large stress is exerted on the punch and the punch may also become broken; and a large shear droop portion is formed adjacent to a punching start point of the shaft hole and may cause a trouble in practical use.

The second punch 61 may have a frusto-conical shape instead of a conical shape.

In the first to sixth embodiments, the gap volume 53b, which is provided between the outer periphery of each of the column portions 7a, 7c, and 7f and the protrusion-including column portions 7b, 7d, and 7e and the inner side wall 53a or 53c of a corresponding one of the first dies 52a to 52f, has a size that satisfies the following conditions. That is, when the first punch 51 is pressed into the column portion 7a, 7c, or 7f, or the protrusion-including column portion 7b, 7d, or 7e of one of the forged workpieces 33a to 33f, a slug is not generated and the column portion 7a, 7c, or 7f or the protrusion-including column portion 7b, 7d, or 7e expands outward when the first punch 51 is pressed into the column portion 7a, 7c, or 7f or the protrusion-including column portion 7b, 7d, or 7e from a punching start point to a position at ⅘ of the length of the column portion 7a, 7c, or 7f or the protrusion-including column portion 7b, 7d, or 7e, and a slug is generated and discharged when the first punch 51 is pressed into the column portion 7a, 7c, or 7f or the protrusion-including column portion 7b, 7d, or 7e from the position at ⅘ of the length of the column portion 7a, 7c, or 7f or the protrusion-including column portion 7b, 7d, or 7e to a punching end point. Alternatively, the value ⅘ may be substituted by a value in the range of ¾ to ⅚.

It is not preferable that this value be outside of this range because, if this value is smaller than ¾, the column portion does not expand in a lower part of the gap volume 53b, and if this value is larger than ⅚, an excessively large stress is exerted on the first punch.

In the first to sixth embodiments, the shaft hole forming step 50 and the shaft hole finishing step 60 are performed by cold working. Alternatively, the shaft hole forming step and the shaft hole finishing step may be performed by warm working.

To perform these steps by warm working, the temperature of the forged workpiece in the cooling step 45 is adjusted to be in the range of 450° C. to 900° C.

In this case, the dimensions of the first punch, the first die, the second punch, and the second die are determined with consideration of thermal expansion of the forged workpiece during warm working and thermal contraction during use at room temperature.

That is, because the punches and dies are made of a material that has a small coefficient of thermal expansion, the first punch, the first die, the second punch, and the second die are manufactured so as to have dimensions that are larger than the design values for use at room temperature with consideration of the temperatures during warm working and the difference in the coefficients of thermal expansion.

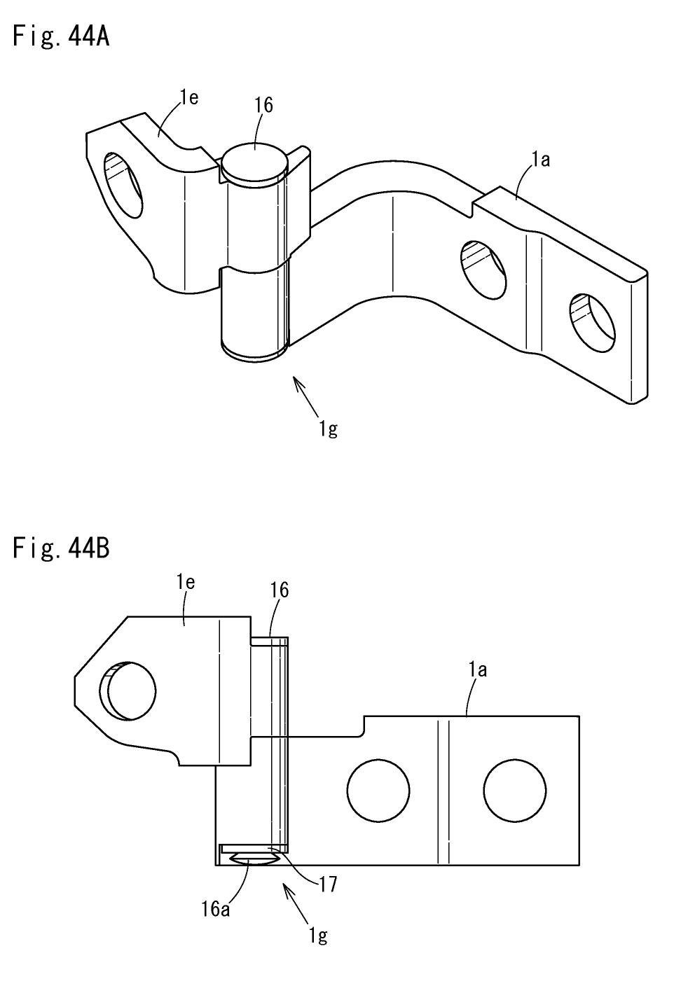

Next, referring to FIGS. 44A and 44B, a method of manufacturing an automobile door hinge according to a seventh embodiment of the present invention will be described.

The seventh embodiment is a method of manufacturing a pair of automobile door hinges by using a body-side door hinge that is manufactured by the method of manufacturing an automobile door hinge according to the first embodiment and a door-side door hinge that is manufactured by the method of manufacturing an automobile door hinge according to the fifth embodiment.

FIGS. 44A and 44B illustrate a pair of automobile door hinges 1g that is made from the body-side door hinge 1a, which is manufactured by the method according to the first embodiment and which is to be attached to an automobile body, and a door-side door hinge 1e, which is manufactured by the method according to the fifth embodiment. A headed hinge pin 16 is inserted into the shaft holes in the door hinges 1a and 1e so that the headed hinge pin extends through the shaft holes. Then, an end portion 16a of the headed hinge pin 16 is swaged. Thus, the pair of automobile door hinges 1g is made.

A washer 17 is disposed at an end of the headed hinge pin 16.

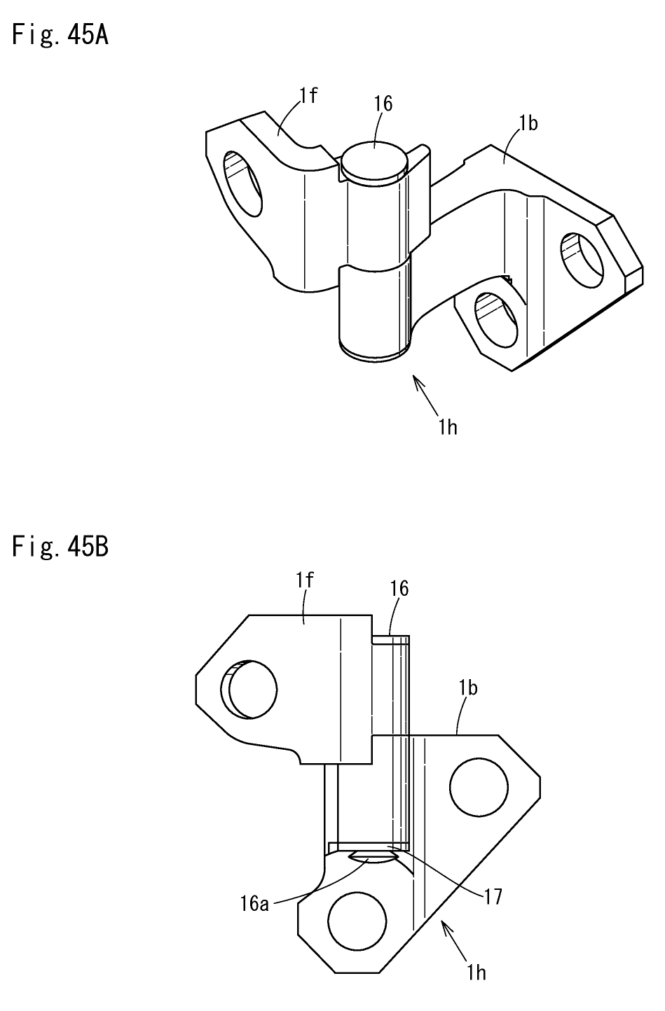

Next, referring to FIGS. 45A and 45B, a method of manufacturing an automobile door hinge according to an eighth embodiment of the present invention will be described.

The eighth embodiment is a method of manufacturing a pair of automobile door hinges by using a body-side door hinge that is manufactured by the method of manufacturing an automobile door hinge according to the second embodiment and a door-side door hinge that is manufactured by the method of manufacturing an automobile door hinge according to the sixth embodiment.

FIGS. 45A and 45B illustrate a pair of automobile door hinges 1h that is made from the body-side door hinge 1b, which is manufactured by the method according to the second embodiment and which is to be attached to an automobile body, and the door-side door hinge 1f, which is manufactured by the method according to the sixth embodiment. A headed hinge pin 16 is inserted into the shaft holes in the door hinges 1b and 1f so that the headed hinge pin extends through the shaft holes. Then, an end portion 16a of the headed hinge pin 16 is swaged. Thus, the pair of automobile door hinges 1h is made.

A washer 17 is disposed at an end of the headed hinge pin 16.

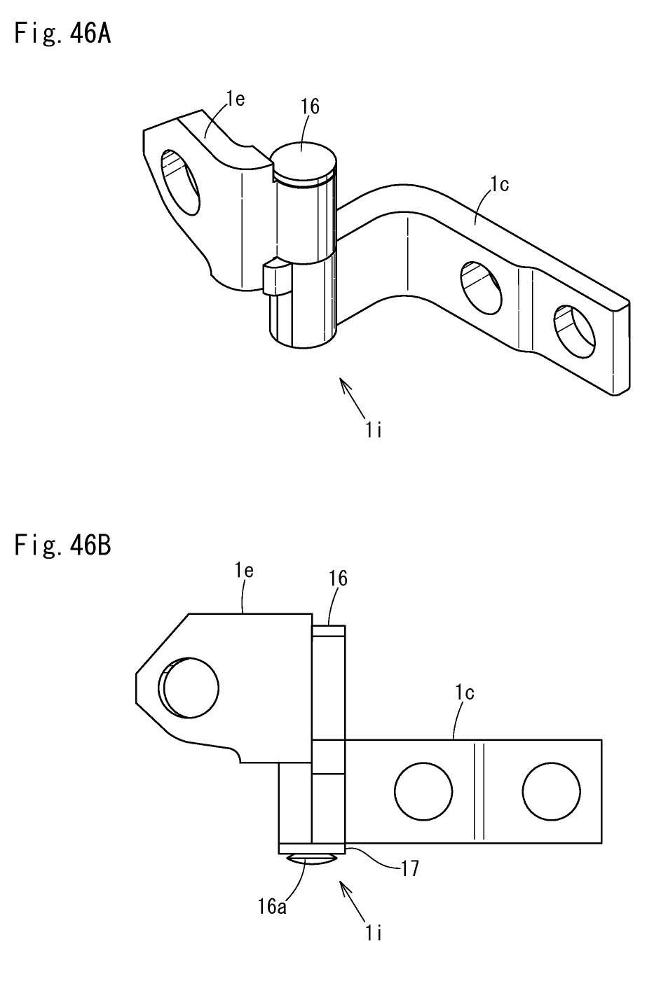

Next, referring to FIGS. 46A and 46B, a method of manufacturing an automobile door hinge according to a ninth embodiment of the present invention will be described.

The ninth embodiment is a method of manufacturing a pair of automobile door hinges by using a body-side door hinge that is manufactured by the method of manufacturing an automobile door hinge according to the third embodiment and a door-side door hinge that is manufactured by the method of manufacturing a door hinge according to the fifth embodiment.

FIGS. 46A and 46B illustrate a pair of automobile door hinges 1i that is made from the body-side door hinge 1c, which is manufactured by the method according to the third embodiment and which is to be attached to an automobile body, and the door-side door hinge 1e, which is manufactured by the method according to the fifth embodiment. A headed hinge pin 16 is inserted into the shaft holes in the door hinges 1c and 1e so that the headed hinge pin extends through the shaft holes. Then, an end portion 16a of the headed hinge pin 16 is swaged. Thus, the pair of automobile door hinges 1i is made.

A washer 17 is disposed at an end of the headed hinge pin 16.

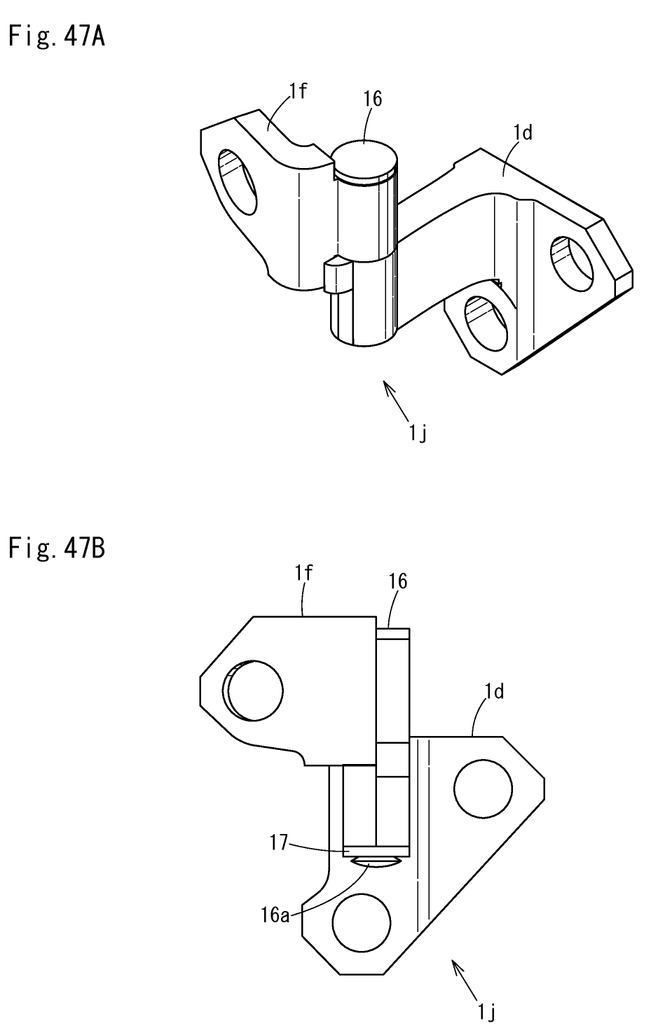

Next, referring to FIGS. 47A and 47B, a method of manufacturing an automobile door hinge according to a tenth embodiment of the present invention will be described.

The tenth embodiment is a method of manufacturing a pair of automobile door hinges by using a body-side door hinge that is manufactured by the method of manufacturing an automobile door hinge according to the fourth embodiment and a door-side door hinge that is manufactured by the method of manufacturing an automobile door hinge according to the sixth embodiment.

FIGS. 47A and 47B illustrate a pair of automobile door hinges 1j that is made from the body-side door hinge 1d, which is manufactured by the method according to the fourth embodiment and is attached to an automobile body, and the door-side door hinge 1f, which is manufactured by the method according to the sixth embodiment. A headed hinge pin 16 is inserted into the shaft holes in the door hinges 1d and 1f so that the headed hinge pin extends through the shaft holes. Then, an end portion 16a of the headed hinge pin 16 is swaged. Thus, the pair of automobile door hinges 1j is made.

A washer 17 is disposed at an end of the headed hinge pin 16.

The method of manufacturing an automobile door hinge according to any of the first to tenth embodiments described above is suitable for manufacturing a door hinge for a large car or a luxury car, which has heavy doors. Needless to say, the methods can be used for small cars and economy cars. In the case of small cars or economy cars, the dimensions specifically described in the above embodiments are made small.

### REFERENCE SIGNS LIST

1a to 1d body-side door hinge
1e, 1f door-side door hinge
1g to 1j pair of automobile door hinges
2a, 2c, 2e material
3, 3c, 3f mounting portion
4 arm portion
5a, 5f engagement portion
5b, 5e protrusion-including engagement portion
6 shaft hole
7a, 7c, 7f column portion
7b, 7d, 7e protrusion-including column portion
9 door stop protrusion
16 headed hinge pin
16a end portion
30 hot forging step
31 lower die
32 upper die
33a to 33f forged workpiece
34a to 34f bent portion
35a to 35f protruding surface
36a to 36f concave portion
37a to 37f opposite surface
38a to 38f convex portion
40 trimming step
50 shaft hole forming step
51 first punch
52a to 52f first die
53a, 53c inner side wall
53b gap volume
60 shaft hole finishing step
61 second punch
62a to 62f second die

1. A method of manufacturing an automobile door hinge through a process including hot forging and punching, the automobile door hinge being made of steel and including a strip-shaped mounting portion, a strip-shaped arm portion that is bent away from the mounting portion, and an engagement portion that is disposed at an end of the arm portion and that has a cylindrical shape, the engagement portion having a shaft hole into which a hinge pin is to be inserted, the method comprising:
a hot forging step of hot forging a round steel bar to form a strip-shaped mounting portion, a strip-shaped arm portion that is bent away from the mounting portion, and a column portion that is disposed at an end of the arm portion and that has a horizontal cross section having a circular or elliptical shape;
a shaft hole forming step of forming a shaft hole, into which a hinge pin is to be inserted, in the column portion formed in the hot forging step by using a first punch and a first die so that the shaft hole extends through an axial center of the column portion; and
a shaft hole finishing step of punching the shaft hole formed in the shaft hole forming step by using a second punch and a second die from a side of the shaft hole on which a punching end point exists at which punching with the first punch has been finished,
wherein, in the hot forging step, a round steel bar, which has been heated to 950° C. to 1350° C., is placed on a lower die, an upper die is dropped onto the round steel bar a plurality of times, and thereby a forged workpiece having a predetermined shape is formed with the dies,
wherein the lower die has a concave portion for receiving a protruding surface on a protruding side of a bent portion of the forged workpiece to be formed in the hot forging step so that the bent portion of the forged workpiece protrudes downward,
wherein the upper die has a convex portion whose shape matches that of an opposite surface of the bent portion of the forged workpiece opposite to the protruding surface,
wherein a height of the shaft hole formed in the shaft hole forming step in the column portion is 2.0 times a diameter of the shaft hole or larger,
wherein the first punch used in the shaft hole forming step includes a tip having a conical shape having a vertex angle in a range of 70° to 120°,
wherein the first die has an inner side wall that is separated from an outer periphery of the column portion of the forged workpiece with a gap therebetween, and a gap volume that is provided between the outer periphery of the column portion and the inner side wall has such a size that, during punching of the column portion of the forged workpiece using the first punch, a slug is not generated and the column portion expands outward when the first punch is pressed into the column portion from a punching start point to a predetermined dimension, and a slug is generated and discharged when the first punch is pressed into the column portion from the predetermined dimension to the punching end point,
wherein the second die has substantially the same shape as the first die, and
wherein the second punch includes a tip having a frusto-conical or conical shape having a vertex angle in a range of 70° to 120°, and the second punch has a maximum diameter that is larger than a maximum diameter of the first punch by 0.1 to 0.3 mm.

2. A method of manufacturing an automobile door hinge through a process including hot forging and punching, the automobile door hinge being made of steel and including a strip-shaped mounting portion, a strip-shaped arm portion that is bent away from the mounting portion, and a protrusion-including engagement portion that is disposed at an end of the arm portion and that has a cylindrical shape, the protrusion-including engagement portion having a shaft hole into which a hinge pin is to be inserted and a door stop protrusion on a distal side of the cylindrical shape, the method comprising:
a hot forging step of hot forging a round steel bar to form a strip-shaped mounting portion, a strip-shaped arm portion that is bent away from the mounting portion, and a protrusion-including column portion that is disposed at an end of the arm portion and that has a horizontal cross section having a circular or elliptical shape, the protrusion-including column portion having a door stop protrusion on a distal side of the circular or elliptical shape;
a shaft hole forming step of forming a shaft hole, into which a hinge pin is to be inserted, in the protrusion-including column portion formed in the hot forging step by using a first punch and a first die so that the shaft hole extends through an axial center of the protrusion-including column portion; and
a shaft hole finishing step of punching the shaft hole formed in the shaft hole forming step by using a second punch and a second die from a side of the shaft hole on which a punching end point exists at which punching with the first punch has been finished,
wherein, in the hot forging step, a round steel bar, which has been heated to 950° C. to 1350° C., is placed on a lower die, an upper die is dropped onto the round steel bar a plurality of times, and thereby a forged workpiece having a predetermined shape is formed with the dies,
wherein the lower die has a concave portion for receiving a protruding surface on a protruding side of a bent portion of the forged workpiece to be formed in the hot forging step so that the bent portion of the forged workpiece protrudes downward,
wherein the upper die has a convex portion whose shape matches that of an opposite surface of the bent portion of the forged workpiece opposite to the protruding surface,
wherein a height of the shaft hole formed in the shaft hole forming step in the protrusion-including column portion is 2.0 times a diameter of the shaft hole or larger,
wherein the first punch used in the shaft hole forming step includes a tip having a conical shape having a vertex angle in a range of 70° to 120°,
wherein the first die has an inner side wall that is separated from an outer periphery of the protrusion-including column portion of the forged workpiece with a gap therebetween, and a gap volume that is provided between the outer periphery of the protrusion-including column portion and the inner side wall has such a size that, during punching of the protrusion-including column portion of the forged workpiece using the first punch, a slug is not generated and the protrusion-including column portion expands outward when the first punch is pressed into the protrusion-including column portion from a punching start point to a predetermined dimension, and a slug is generated and discharged when the first punch is pressed into the protrusion-including column portion from the predetermined dimension to the punching end point,
wherein the second die has substantially the same shape as the first die, and
wherein the second punch includes a tip having a frusto-conical or conical shape having a vertex angle in a range of 70° to 120°, and the second punch has a maximum diameter that is larger than a maximum diameter of the first punch by 0.1 to 0.3 mm.

3. A method of manufacturing an automobile door hinge through a process including hot forging and punching, the automobile door hinge being made of steel and including a polygonal plate-shaped mounting portion, a strip-shaped arm portion that is bent away from the mounting portion and that has a dimension smaller than a height dimension of the mounting portion, and an engagement portion that is disposed at an end of the arm portion and that has a cylindrical shape, the engagement portion having a shaft hole into which a hinge pin is to be inserted, the method comprising:
a hot forging step of hot forging a round steel bar to form a polygonal plate-shaped mounting portion, a strip-shaped arm portion that is bent away from the mounting portion and that has a dimension smaller than a height dimension of the mounting portion, and a column portion that is disposed at an end of the arm portion and that has a horizontal cross section having a circular or elliptical shape;
a shaft hole forming step of forming a shaft hole, into which a hinge pin is to be inserted, in the column portion formed in the hot forging step by using a first punch and a first die so that the shaft hole extends through an axial center of the column portion; and
a shaft hole finishing step of punching the shaft hole formed in the shaft hole forming step by using a second punch and a second die from a side of the shaft hole on which a punching end point exists at which punching with the first punch has been finished,
wherein, in the hot forging step, a round steel bar, which has been heated to 950° C. to 1350° C., is placed on a lower die, an upper die is dropped onto the round steel bar a plurality of times, and thereby a forged workpiece having a predetermined shape is formed with the dies,
wherein the lower die has a concave portion for receiving a protruding surface on a protruding side of a bent portion of the forged workpiece to be formed in the hot forging step so that the bent portion of the forged workpiece protrudes downward,
wherein the upper die has a convex portion whose shape matches that of an opposite surface of the bent portion of the forged workpiece opposite to the protruding surface,
wherein a height of the shaft hole formed in the shaft hole forming step in the column portion is 2.0 times a diameter of the shaft hole or larger,
wherein the first punch used in the shaft hole forming step includes a tip having a conical shape having a vertex angle in a range of 70° to 120°,
wherein the first die has an inner side wall that is separated from an outer periphery of the column portion of the forged workpiece with a gap therebetween, and a gap volume that is provided between the outer periphery of the column portion and the inner side wall has such a size that, during punching of the column portion of the forged workpiece using the first punch, a slug is not generated and the column portion expands outward when the first punch is pressed into the column portion from a punching start point to a predetermined dimension, and a slug is generated and discharged when the first punch is pressed into the column portion from the predetermined dimension to the punching end point,
wherein the second die has substantially the same shape as the first die, and
wherein the second punch includes a tip having a frusto-conical or conical shape having a vertex angle in a range of 70° to 120°, and the second punch has a maximum diameter that is larger than a maximum diameter of the first punch by 0.1 to 0.3 mm.

4. A method of manufacturing an automobile door hinge through a process including hot forging and punching, the automobile door hinge being made of steel and including a polygonal plate-shaped mounting portion, a strip-shaped arm portion that is bent away from the mounting portion and that has a dimension smaller than a height dimension of the mounting portion, a protrusion-including engagement portion that is disposed at an end of the arm portion and that has a cylindrical shape, the protrusion-including engagement portion having a shaft hole into which a hinge pin is to be inserted and a door stop protrusion on a distal side of the cylindrical shape, the method comprising:
a hot forging step of hot forging a round steel bar to form a polygonal plate-shaped mounting portion, a strip-shaped arm portion that is bent away from the mounting portion and that has a dimension smaller than a height dimension of the mounting portion, and a protrusion-including column portion that is disposed at an end of the arm portion and that has a horizontal cross section having a circular or elliptical shape, the protrusion-including column portion having a door stop protrusion on a distal side of the circular or elliptical shape;
a shaft hole forming step of forming a shaft hole, into which a hinge pin is to be inserted, in the protrusion-including column portion formed in the hot forging step by using a first punch and a first die so that the shaft hole extends through an axial center of the protrusion-including column portion; and
a shaft hole finishing step of punching the shaft hole formed in the shaft hole forming step by using a second punch and a second die from a side of the shaft hole on which a punching end point exists at which punching with the first punch has been finished,
wherein, in the hot forging step, a round steel bar, which has been heated to 950° C. to 1350° C., is placed on a lower die, an upper die is dropped onto the round steel bar a plurality of times, and thereby a forged workpiece having a predetermined shape is formed with the dies,
wherein the lower die has a concave portion for receiving a protruding surface on a protruding side of a bent portion of the forged workpiece to be formed in the hot forging step so that the bent portion of the forged workpiece protrudes downward,
wherein the upper die has a convex portion whose shape matches that of an opposite surface of the bent portion of the forged workpiece opposite to the protruding surface,
wherein a height of the shaft hole formed in the shaft hole forming step in the protrusion-including column portion is 2.0 times a diameter of the shaft hole or larger,
wherein the first punch used in the shaft hole forming step includes a tip having a conical shape having a vertex angle in a range of 70° to 120°,
wherein the first die has an inner side wall that is separated from an outer periphery of the protrusion-including column portion of the forged workpiece with a gap therebetween, and a gap volume that is provided between the outer periphery of the protrusion-including column portion and the inner side wall has such a size that, during punching of the protrusion-including column portion of the forged workpiece using the first punch, a slug is not generated and the protrusion-including column portion expands outward when the first punch is pressed into the protrusion-including column portion from a punching start point to a predetermined dimension, and a slug is generated and discharged when the first punch is pressed into the protrusion-including column portion from the predetermined dimension to the punching end point,
wherein the second die has substantially the same shape as the first die, and
wherein the second punch includes a tip having a frusto-conical or conical shape having a vertex angle in a range of 70° to 120°, and the second punch has a maximum diameter that is larger than a maximum diameter of the first punch by 0.1 to 0.3 mm.

5. A method of manufacturing an automobile door hinge through a process including hot forging and punching, the automobile door hinge being made of steel and including a strip-shaped mounting portion and a protrusion-including engagement portion that is disposed in a portion bent away from the mounting portion and that has a cylindrical shape, the protrusion-including engagement portion having a shaft hole into which a hinge pin is to be inserted and a door stop protrusion on a distal side of the cylindrical shape, the method comprising:
a hot forging step of hot forging a round steel bar to form a strip-shaped mounting portion and a protrusion-including column portion that is disposed in a portion bent away from the mounting portion and that has a horizontal cross section having a circular or elliptical shape, the protrusion-including column portion having a door stop protrusion on a distal side of the cylindrical or elliptical shape;
a shaft hole forming step of forming a shaft hole, into which a hinge pin is to be inserted, in the protrusion-including column portion formed in the hot forging step by using a first punch and a first die so that the shaft hole extends through an axial center of the protrusion-including column portion; and
a shaft hole finishing step of punching the shaft hole formed in the shaft hole forming step by using a second punch and a second die from a side of the shaft hole on which a punching end point exists at which punching with the first punch has been finished,
wherein, in the hot forging step, a round steel bar, which has been heated to 950° C. to 1350° C., is placed on a lower die, an upper die is dropped onto the round steel bar a plurality of times, and thereby a forged workpiece having a predetermined shape is formed with the dies,
wherein the lower die has a concave portion for receiving a protruding surface on a protruding side of a bent portion of the forged workpiece to be formed in the hot forging step so that the bent portion of the forged workpiece protrudes downward,
wherein the upper die has a convex portion whose shape matches that of an opposite surface of the bent portion of the forged workpiece opposite to the protruding surface,
wherein a height of the shaft hole formed in the shaft hole forming step in the protrusion-including column portion is 2.0 times a diameter of the shaft hole or larger,
wherein the first punch used in the shaft hole forming step includes a tip having a conical shape having a vertex angle in a range of 70° to 120°,
wherein the first die has an inner side wall that is separated from an outer periphery of the protrusion-including column portion of the forged workpiece with a gap therebetween, and a gap volume that is provided between the outer periphery of the protrusion-including column portion and the inner side wall has such a size that, during punching of the protrusion-including column portion of the forged workpiece using the first punch, a slug is not generated and the protrusion-including column portion expands outward when the first punch is pressed into the protrusion-including column portion from a punching start point to a predetermined dimension, and a slug is generated and discharged when the first punch is pressed into the protrusion-including column portion from the predetermined dimension to the punching end point,
wherein the second die has substantially the same shape as the first die, and
wherein the second punch includes a tip having a frusto-conical or conical shape having a vertex angle in a range of 70° to 120°, and the second punch has a maximum diameter that is larger than a maximum diameter of the first punch by 0.1 to 0.3 mm.

6. A method of manufacturing an automobile door hinge through a process including hot forging and punching, the automobile door hinge being made of steel and including a strip-shaped mounting portion and an engagement portion that is disposed in a portion bent away from the mounting portion and that has a cylindrical shape, the engagement portion having a shaft hole into which a hinge pin is to be inserted, the method comprising:
a hot forging step of hot forging a round steel bar to form a strip-shaped mounting portion and a column portion that is disposed in a portion bent away from the mounting portion and that has a horizontal cross section having a circular or elliptical shape;
a shaft hole forming step of forming a shaft hole, into which a hinge pin is to be inserted, in the column portion formed in the hot forging step by using a first punch and a first die so that the shaft hole extends through an axial center of the column portion; and
a shaft hole finishing step of punching the shaft hole formed in the shaft hole forming step by using a second punch and a second die from a side of the shaft hole on which a punching end point exists at which punching with the first punch has been finished,
wherein, in the hot forging step, a round steel bar, which has been heated to 950° C. to 1350° C., is placed on a lower die, an upper die is dropped onto the round steel bar a plurality of times, and thereby a forged workpiece having a predetermined shape is formed with the dies,
wherein the lower die has a concave portion for receiving a protruding surface on a protruding side of a bent portion of the forged workpiece to be formed in the hot forging step so that the bent portion of the forged workpiece protrudes downward,
wherein the upper die has a convex portion whose shape matches that of an opposite surface of the bent portion of the forged workpiece opposite to the protruding surface,
wherein a height of the shaft hole formed in the shaft hole forming step in the column portion is 2.0 times a diameter of the shaft hole or larger,
wherein the first punch used in the shaft hole forming step includes a tip having a conical shape having a vertex angle in a range of 70° to 120°,
wherein the first die has an inner side wall that is separated from an outer periphery of the column portion of the forged workpiece with a gap therebetween, and a gap volume that is provided between the outer periphery of the column portion and the inner side wall has such a size that, during punching of the column portion of the forged workpiece using the first punch, a slug is not generated and the column portion expands outward when the first punch is pressed into the column portion from a punching start point to a predetermined dimension, and a slug is generated and discharged when the first punch is pressed into the column portion from the predetermined dimension to the punching end point,
wherein the second die has substantially the same shape as the first die, and
wherein the second punch includes a tip having a frusto-conical or conical shape having a vertex angle in a range of 70° to 120°, and the second punch has a maximum diameter that is larger than a maximum diameter of the first punch by 0.1 to 0.3 mm.

7. The method of manufacturing an automobile door hinge according to claim 1, further comprising a trimming step of removing a burr of the forged workpiece formed in the hot forging step by using a trimming press,
wherein the trimming step is performed after the hot forging step while the forged workpiece is hot.

8. The method of manufacturing an automobile door hinge according to claim 1, wherein, in the hot forging step, a round steel bar having a temperature in the range of 1200° C.±50° C. is forged.

9. The method of manufacturing an automobile door hinge according to claim 1, wherein the shaft hole forming step is performed by cold working.

10. The method of manufacturing an automobile door hinge according to claim 2, further comprising a trimming step of removing a burr of the forged workpiece formed in the hot forging step by using a trimming press,
wherein the trimming step is performed after the hot forging step while the forged workpiece is hot.

11. The method of manufacturing an automobile door hinge according to claim 3, further comprising a trimming step of removing a burr of the forged workpiece formed in the hot forging step by using a trimming press,
wherein the trimming step is performed after the hot forging step while the forged workpiece is hot.

12. The method of manufacturing an automobile door hinge according to claim 4, further comprising a trimming step of removing a burr of the forged workpiece formed in the hot forging step by using a trimming press,
wherein the trimming step is performed after the hot forging step while the forged workpiece is hot.

13. The method of manufacturing an automobile door hinge according to claim 5, further comprising a trimming step of removing a burr of the forged workpiece formed in the hot forging step by using a trimming press,
wherein the trimming step is performed after the hot forging step while the forged workpiece is hot.

14. The method of manufacturing an automobile door hinge according to claim 6, further comprising a trimming step of removing a burr of the forged workpiece formed in the hot forging step by using a trimming press,
wherein the trimming step is performed after the hot forging step while the forged workpiece is hot.

15. The method of manufacturing an automobile door hinge according to claim 2, wherein, in the hot forging step, a round steel bar having a temperature in the range of 1200° C.±50° C. is forged.

16. The method of manufacturing an automobile door hinge according to claim 3, wherein, in the hot forging step, a round steel bar having a temperature in the range of 1200° C.±50° C. is forged.

17. The method of manufacturing an automobile door hinge according to claim 4, wherein, in the hot forging step, a round steel bar having a temperature in the range of 1200° C.±50° C. is forged.

18. The method of manufacturing an automobile door hinge according to claim 5, wherein, in the hot forging step, a round steel bar having a temperature in the range of 1200° C.±50° C. is forged.

19. The method of manufacturing an automobile door hinge according to claim 6, wherein, in the hot forging step, a round steel bar having a temperature in the range of 1200° C.±50° C. is forged.

20. The method of manufacturing an automobile door hinge according to claim 2, wherein the shaft hole forming step is performed by cold working.

21. The method of manufacturing an automobile door hinge according to claim 3, wherein the shaft hole forming step is performed by cold working.

22. The method of manufacturing an automobile door hinge according to claim 4, wherein the shaft hole forming step is performed by cold working.

23. The method of manufacturing an automobile door hinge according to claim 5, wherein the shaft hole forming step is performed by cold working.

24. The method of manufacturing an automobile door hinge according to claim 6, wherein the shaft hole forming step is performed by cold working.
